(19) United States
(12) Patent Application Publication
(10) Pub. No.: US 2025/0066081 A1
(43) Pub. Date: Feb. 27, 2025

(54) LIQUID-CONTAINING CONTAINER, LIQUID-CONTAINING COMBINED CONTAINER, CONTAINER, STOPPER, AND METHOD FOR PRODUCING LIQUID-CONTAINING CONTAINER

(71) Applicant: DAI NIPPON PRINTING CO., LTD., Tokyo-to (JP)

(72) Inventors: Noriko KUMAZAWA, Tokyo-to (JP); Takuma BABA, Tokyo-to (JP); Noriko NAKATA, Tokyo-to (JP); Kouichi TATSUMI, Tokyo-to (JP); Kazumasa YAMAKI, Tokyo-to (JP)

(73) Assignee: DAI NIPPON PRINTING CO., LTD., Tokyo-to (JP)

(21) Appl. No.: 18/725,469

(22) PCT Filed: Dec. 28, 2022
(86) PCT No.: PCT/JP2022/048661

§ 371 Date: Jun. 28, 2024

(30) Foreign Application Priority Data
Dec. 28, 2021 (JP) 2021-215259

(51) Int. Cl. B65D 39/00; B65D 81/26

(52) U.S. Cl. CPC B65D 39/0023; B65D 81/266; B65D 2539/008

(57) ABSTRACT

A liquid-containing container is the liquid-containing container containing a liquid and includes a container body with an opening portion and a stopper that closes the opening portion and has oxygen permeability. The stopper includes a stopper body portion and a barrier layer provided on at least part of a surface of the stopper body portion. The barrier layer constitutes at least a surface of a portion of the stopper to be inserted into the container body and a surface of the stopper defining a storage space for the liquid and includes at least one selected from the group consisting of a p-xylylene layer, a diamond-like carbon layer, and a fluoropolymer layer.

### TECHNICAL FIELD

The present disclosure relates to a liquid-containing container, a liquid-containing combined container, a container set, and a method for producing a liquid-containing container.

### BACKGROUND ART

A container for containing a liquid is known (for example, Patent Literature 1). Depending on the type of liquid, the liquid is decomposed by oxygen in the container. To address this issue, it is considered to use a container with an oxygen barrier property.

### CITATION LIST

### Patent Literature

PTL 1: Japanese Unexamined Patent Application Publication No. 2011-212366

### SUMMARY OF INVENTION

However, oxygen may be dissolved in a liquid during the production of the liquid. A container with an oxygen barrier property cannot address the degradation of a liquid due to dissolved oxygen in the liquid. Thus, the related art cannot sufficiently suppress the oxygen-induced degradation of a liquid in a container.

For example, for a container, such as a vial, that includes a container body and a stopper for closing an opening portion of the container body, the following method is considered as a method for suppressing the oxygen-induced degradation of a liquid in the container. While an opening portion of a container body is closed with a stopper, oxygen in the container is discharged to the outside of the container through the stopper to reduce the concentration of oxygen in the container. This suppresses the oxygen-induced degradation of a liquid in the container.

On the other hand, when a material of a stopper of a container, such as a vial, comes into contact with a liquid in the container, the liquid may react with a material of the stopper and degrade. To suppress the reaction of the liquid with a material of the stopper and its degradation, a portion of the stopper that can come into contact with the liquid may be formed of a barrier layer with low reactivity. In such a case, however, the barrier layer may prevent oxygen permeation through the stopper.

It is an object of the present disclosure to discharge oxygen in a container to the outside of the container through a stopper while suppressing the reaction of a liquid in the container with a material of the stopper.

A liquid-containing container according to the present disclosure is
a liquid-containing container containing a liquid, including:
a container body with an opening portion; and a stopper that closes the opening portion and has oxygen permeability,
wherein the stopper includes a stopper body portion and a barrier layer provided on at least part of a surface of the stopper body portion, and
the barrier layer constitutes at least a surface of a portion of the stopper to be inserted into the container body and a surface of the stopper defining a storage space for the liquid and includes at least one selected from the group consisting of a p-xylylene layer, a diamond-like carbon layer, and a fluoropolymer layer.

In a liquid-containing container according to the present disclosure, the stopper body portion may contain silicone.

In a liquid-containing container according to the present disclosure, a total oxygen permeability coefficient αₐₗₗ (cm³·20μm/(m²·day·atm)) of the stopper, a thickness w1 (μm) of the stopper body portion, a thickness w2 (μm) of the barrier layer, and an opening area A (m²) of the opening portion may satisfy the following formula (1).

$$[ Math . 1 ]$$

$${α}_{all} \times 20 / ( w 1 + w 2 ) \geq 0.1 / A \qquad formula ( 1 )$$

In a liquid-containing container according to the present disclosure, an oxygen permeability coefficient α1 (cm³·20 μm/(m²·day·atm)) of the stopper body portion, an oxygen permeability coefficient α2 (cm³·20 μm/(m²·day·atm)) of the barrier layer, and a thickness w2 (μm) of the barrier layer may satisfy the following formula (2).

$$[ Math . 2 ]$$

$$α1 / 1000 \leq α2 / w 2 \qquad formula ( 2 )$$

In a liquid-containing container according to the present disclosure,
the barrier layer may be formed of the p-xylylene layer or the diamond-like carbon layer, and
the barrier layer may have a thickness of 1000 nm or less.

In a liquid-containing container according to the present disclosure,
the barrier layer may be formed of the p-xylylene layer or the diamond-like carbon layer, and
the barrier layer may have a thickness of 200 nm or more.

In a liquid-containing container according to the present disclosure,
the barrier layer may be formed of the fluoropolymer layer, and
the barrier layer may have a thickness of 50 μm or less.

In a liquid-containing container according to the present disclosure,
the barrier layer may be formed of the fluoropolymer layer, and
the barrier layer may have a thickness of 10 μm or more.

In a liquid-containing container according to the present disclosure,
the stopper body portion may constitute a surface of the stopper forming an outer surface of the liquid-containing container.

In a liquid-containing container according to the present disclosure,
the stopper body portion may constitute a surface of the stopper that comes into contact with an end portion of the opening portion of the container body.

In a liquid-containing container according to the present disclosure,
the container body may have an oxygen barrier property.

In a liquid-containing container according to the present disclosure,
the stopper may come into contact with an end portion of the opening portion of the container body and close the opening portion so as to seal the liquid.

In a liquid-containing container according to the present disclosure,
the stopper body portion may have a thickness of 0.5 mm or more and 3 mm or less.

In a liquid-containing container according to the present disclosure,
the liquid-containing container according to any one of claims 1 to 13, wherein the container including the container body and the stopper has a total oxygen permeation amount of 0.9 (cm³/(day·atm)) or more.

In a liquid-containing container according to the present disclosure,
the liquid-containing container according to any one of claims 1 to 14, wherein the stopper has an oxygen permeation amount of 2 (cm³/(day·atm)) or more.

In a liquid-containing container according to the present disclosure,
the liquid-containing container according to any one of claims 1 to 15, wherein the stopper has a thickness of 0.5 mm or more and 3 mm or less.

A liquid-containing combined container according to the present disclosure includes:
the liquid-containing container; and
a barrier container that stores the liquid-containing container and has an oxygen barrier property.

A liquid-containing combined container according to the present disclosure may contain
a deoxidizer for absorbing oxygen in the barrier container.

A container according to the present disclosure is
a container for containing a liquid, including:
a container body with an opening portion; and a stopper that closes the opening portion and has oxygen permeability,
wherein the stopper includes a stopper body portion containing silicone and a barrier layer provided on at least part of a surface of the stopper body portion, and
the barrier layer constitutes at least a surface of a portion of the stopper to be inserted into the container body and a surface of the stopper defining a storage space for the liquid and includes at least one selected from the group consisting of a p-xylylene layer, a diamond-like carbon layer, and a fluoropolymer layer.

A stopper according to the present disclosure is
a stopper that closes an opening portion of a container body of a container for containing a liquid and has oxygen permeability, including:
a stopper body portion containing silicone and a barrier layer provided on at least part of a surface of the stopper body portion,
wherein the barrier layer constitutes at least a surface of a portion of the stopper to be inserted into the container body and a surface of the stopper defining a storage space for the liquid and includes at least one selected from the group consisting of a p-xylylene layer, a diamond-like carbon layer, and a fluoropolymer layer.

A method for producing a liquid-containing container according to the present disclosure, including:
a step of closing a barrier container that stores a container; and
a step of adjusting an amount of oxygen in the container,
wherein the container includes a container body that contains a liquid and has an opening portion and a stopper that closes the opening portion and has oxygen permeability,
the stopper includes a stopper body portion containing silicone and a barrier layer provided on at least part of a surface of the stopper body portion,
the barrier layer constitutes at least a surface of a portion of the stopper to be inserted into the container body and a surface of the stopper defining a storage space for the liquid and includes at least one selected from the group consisting of a p-xylylene layer, a diamond-like carbon layer, and a fluoropolymer layer, and
in the step of adjusting the amount of oxygen, a concentration of oxygen in the container is reduced by permeation of oxygen in the container through the stopper.

The present disclosure can discharge oxygen in a container to the outside of the container through a stopper while suppressing the reaction of a liquid in the container with a material of the stopper.

### BRIEF DESCRIPTION OF DRAWINGS

FIG. 1 is an explanatory view of an embodiment of the present disclosure and is a perspective view of an example of a liquid-containing combined container.

FIG. 2A is a longitudinal sectional view of a liquid-containing container that can be included in the liquid-containing combined container of FIG. 1.

FIG. 2B is a longitudinal sectional view of a method for measuring the oxygen permeation amount in a stopper of the container illustrated in FIG. 2A.

FIG. 2C is a longitudinal sectional view of another method for measuring the oxygen permeation amount in the stopper of the container illustrated in FIG. 2A.

FIG. 3 is a longitudinal sectional view of a stopper that can be included in the liquid-containing container of FIG. 2A.

FIG. 4 is a longitudinal sectional view of another example of a stopper.

FIG. 5A is a longitudinal sectional view of still another example of a stopper.

FIG. 5B is a longitudinal sectional view of still another example of a stopper.

FIG. 6A is a perspective view of another example of a barrier container.

FIG. 6B is a plan view of still another example of a barrier container.

FIG. 6C is a plan view of still another example of a barrier container.

FIG. 6D is a perspective view of still another example of a barrier container.

FIG. 7 is a perspective view of still another example of a barrier container.

FIG. 8 is a view of an example of a method for producing the liquid-containing combined container of FIG. 1 and the liquid-containing container of FIG. 2A.

FIG. 9 is a view of an example of a method for producing the liquid-containing combined container of FIG. 1 and the liquid-containing container of FIG. 2A.

FIG. 10 is a view of an example of a method for producing the liquid-containing combined container of FIG. 1 and the liquid-containing container of FIG. 2A.

FIG. 11 is a cross-sectional view of an example of a deoxidizing member containing a deoxidizer.

FIG. 12 is a cross-sectional view of an example of a deoxidizing film containing a deoxidizer.

FIG. 13 is a perspective view of a method of using the liquid-containing container of FIG. 2A.

FIG. 14 is a longitudinal sectional view of a modified example of a stopper.

FIG. 15 is a schematic view of an example of a vapor deposition apparatus.

### DESCRIPTION OF EMBODIMENTS

An embodiment of the present disclosure is described below with reference to the accompanying drawings. In the accompanying drawings of the present description, for the sake of illustration and clarity, the scale, the aspect ratio, and the like are appropriately changed and exaggerated from those of real things.

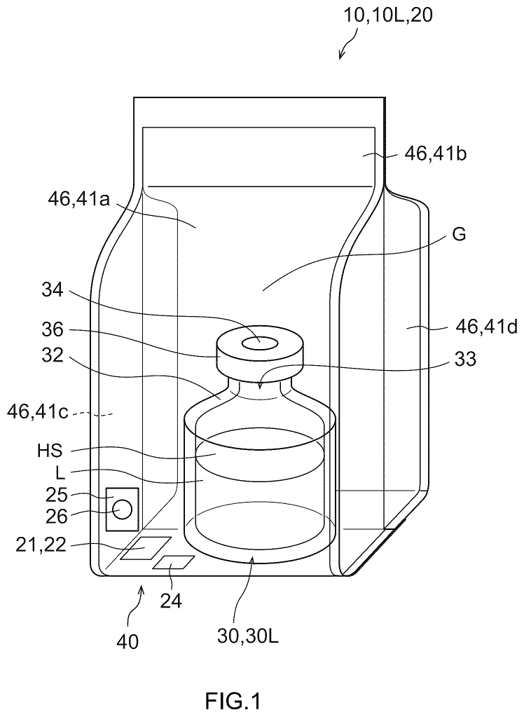

FIGS. 1 to 13 are explanatory views of an embodiment of the present disclosure. FIG. 1 is a perspective view of a liquid-containing combined container 10L according to the present embodiment. As illustrated in FIG. 1, the liquid-containing combined container 10L includes a liquid-containing container 30L containing a fluid L and a barrier container 40. The liquid-containing container 30L includes a container 30 and the liquid L in the container 30. The container 30 and the barrier container 40 that can store the container 30 are collectively referred to as a container set 20. The barrier container 40 has an oxygen barrier property. The barrier container 40 can store the liquid-containing container 30L. The liquid-containing combined container 10L includes the liquid-containing container 30L and the barrier container 40, and the barrier container 40 stores the liquid-containing container 30L. In the liquid-containing combined container 10L, not only the concentration of oxygen in the container 30 but also the amount of oxygen dissolved in the liquid L can be adjusted by the concentration of oxygen in the barrier container 40.

Components of the liquid-containing combined container 10L are described in further detail below with reference to specific examples. First, the liquid-containing container 30L is described below.

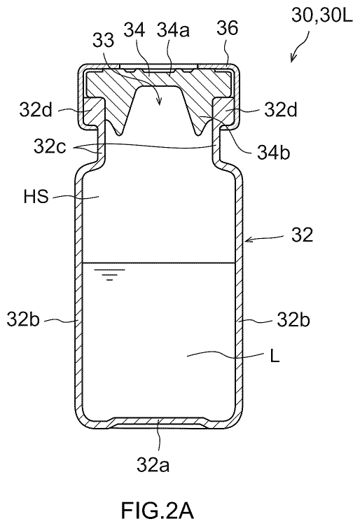

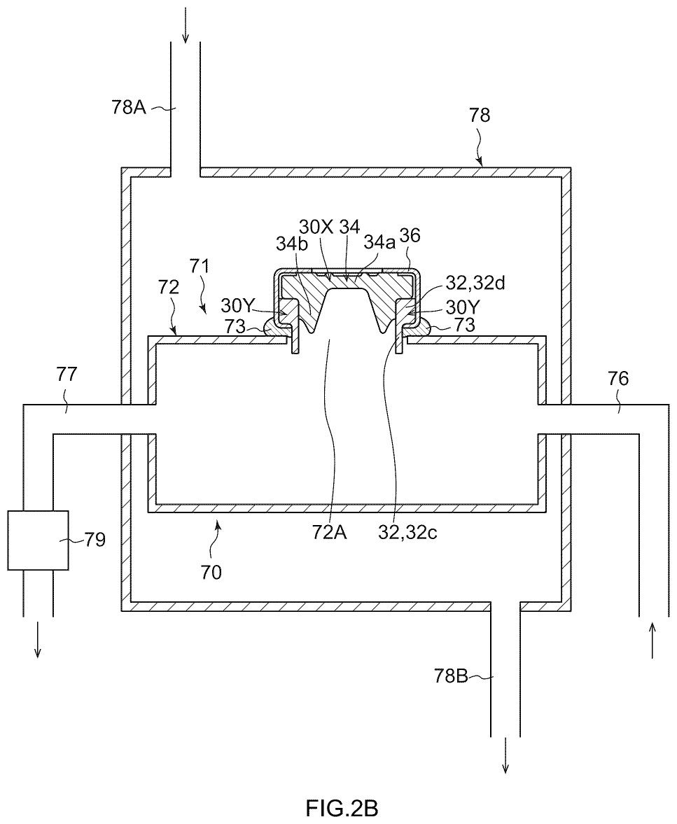

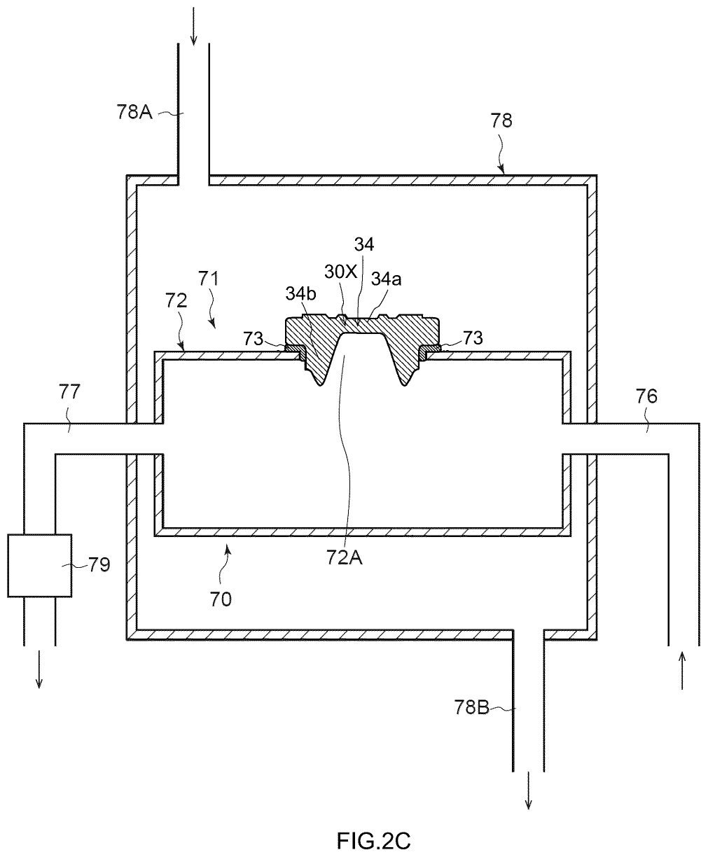

FIG. 2A is a longitudinal sectional view of the liquid-containing container 30L that may be included in the liquid-containing combined container of FIG. 1. As illustrated in FIG. 2A, the liquid-containing container 30L includes the container 30 and the liquid L in the container 30. The container 30 in the present embodiment has oxygen permeability. On the other hand, the container 30 can be sealed to contain the liquid L. Thus, the container 30 is impermeable to the liquid L while being permeable to oxygen. The container 30 with oxygen permeability is an air-tight container.

The air-tight container refers to a container without gas leakage detected by an immersion method specified in JIS Z 2330:2012. More specifically, when a container containing a gas is immersed in water, a container that can prevent bubbles from leaking is considered to be an air-tight container. An air-tight container is also determined to be in an air-tight state when leakage of bubbles from the container containing a gas immersed in water is not observed. In an immersion test, a container to be tested is immersed to a depth of 10 cm or more and 30 cm or less from the water surface. The presence or absence of bubbles is judged by visual observation for 10 minutes.

The container 30 has a stopper 34. FIG. 2A illustrates the external shape of the stopper 34 without illustrating the boundary between a stopper body portion 35 and a barrier layer 81 of the stopper 34 of the container 30. The container 30 has oxygen permeability at the stopper 34.

The container 30 may contain any liquid L. The liquid may be a solution containing a solvent and a solute dissolved in the solvent. The solvent is not particularly limited. The solvent may be water or an alcohol. The liquid L is not limited to a liquid in a strict sense and may be a suspension in which solid particles are dispersed. The liquid L as a food may be tea, coffee, black tea, soup, juice, soup stock, or a concentrate of one or more of these. The liquid L as a chemical may be an internal medicine, an external medicine, or an injection. Other than food and chemicals, the liquid L may be blood or body fluid.

The interior of the container 30 may be under sterile conditions. The liquid L may be a liquid to be kept under sterile conditions. The liquid L to be kept under sterile conditions includes a highly sensitive liquid, such as food or a chemical. A highly sensitive liquid L is likely to be degraded by post-sterilization performed after the production. A highly sensitive liquid cannot be post-sterilized. The post-sterilization is, for example, high-pressure steam sterilization, dry-heat sterilization, radiation sterilization, ethylene oxide gas sterilization, hydrogen peroxide gas plasma sterilization, or the like. A highly sensitive liquid L in the present description refers to a liquid in which 5% or more by weight of all active ingredients in the liquid are decomposed by post-sterilizing the liquid L, and 1% or more by weight of one or more active ingredients in the liquid are decomposed by post-sterilizing the liquid L. A highly sensitive liquid L that cannot be post-sterilized can be produced using production lines in a sterile environment. In other words, it can be produced by aseptic manipulation. The highly sensitive liquid L is, for example, an anticancer agent, an antiviral agent, a vaccine, an antipsychotic agent, or the like.

The amount of oxygen in the liquid L produced by aseptic manipulation can be adjusted by inert gas replacement in the entire space in which production lines of the liquid L are arranged. However, providing an inert gas atmosphere in the entire space in which production lines of the liquid L are arranged requires enormous capital investment. Thus, the amount of oxygen in a container containing a highly sensitive liquid has been adjusted by replacing the atmosphere in the container with an inert gas, by bubbling the liquid L with an inert gas, or the like.

In contrast, according to the idea of the present inventors described below, the concentration of oxygen in the barrier container 40 can be sufficiently reduced, for example, to less than 0.3%, 0.1% or less, 0.05% or less, less than 0.03%, or even 0%, by storing the liquid-containing container 30L in the barrier container 40. Furthermore, the concentration of oxygen (%) in the container 30 can be sufficiently reduced in a short period, and the amount of oxygen (mg/L) dissolved in the liquid L can be sufficiently reduced. For example, the amount of oxygen dissolved in the liquid L can be reduced to less than 0.15 mg/L, 0.04 mg/L or less, 0.03 mg/L or less, 0.02 mg/L or less, even less than 0.015 mg/L, and even 0 mg/L. It can be said that the operation and effect resulting from the idea of the present inventors are remarkable beyond the range predicted from the state of the art.

A product (liquid L) and the inside of a container containing the product described as “sterilized”, “sterile”, or the like, and a product (liquid L), such as a pharmaceutical agent, and the inside of a container containing the product for which “sterile” is a condition for commercialization correspond to the “sterile conditions”. A product (liquid L) and the inside of a container containing the product satisfying a sterility assurance level (SAL) of 10⁻⁶ defined in JIS T0806: 2014 also correspond to “sterile” as used herein. A product and the inside of a container containing the product in which bacteria do not grow when stored at a temperature equal to or higher than room temperature (for example, 20° C.) for 4 weeks are also “sterile” as used herein. A product and the inside of a container containing the product in which bacteria do not grow when stored in a refrigeration state (for example, 8° C. or less) for 8 weeks or more are also “sterile” as used herein. A chemical and the inside of a container containing the chemical in which bacteria do not grow when stored at a temperature of 28° C. or more and 32° C. or less for 2 weeks are also “sterile” as used herein.

Next, the container 30 for containing the liquid L is described. As described above, the container 30 can be sealed to contain the liquid L. In other words, the container 30 can hold the liquid L without leakage.

As illustrated in FIG. 2A, the container 30 has a container body 32 with an opening portion 33 and the stopper 34 for closing the opening portion 33.

The stopper 34 is described below. The stopper 34 has oxygen permeability. Thus, the concentration of oxygen in the container 30 can be adjusted by discharging oxygen in the container 30 to the outside of the container 30 through the stopper 34.

The phrase “the stopper 34 has oxygen permeability” means that, in a state where the stopper 34 closes the opening portion 33 of the container body 32 and in an atmosphere with a temperature of 23° C. and a humidity of 40% RH, oxygen can permeate the stopper 34 at a predetermined oxygen permeation amount or more and can be transferred between the inside and the outside of the container 30. The predetermined oxygen permeation amount is 0.1 (cm³/(day·atm)) or more. The predetermined oxygen permeation amount may be 1 (cm³/(day·atm)) or more, 1.2 (cm³/(day·atm)) or more, or 3 (cm³/(day·atm)) or more. The amount of oxygen in the container 30 can be adjusted by oxygen permeation through the stopper 34 with oxygen permeability. In particular, the stopper 34 with oxygen permeability, that is, the stopper 34 with an oxygen permeation amount of 0.1 (cm³/(day·atm)) or more allows oxygen in the container 30 to be discharged to the outside of the container 30 through the stopper 34. In particular, the amount of oxygen in the container 30 can be efficiently adjusted by producing the liquid-containing combined container 10L including the container 30 with the stopper 34 and the barrier container 40 and by transferring oxygen from the container 30 to the barrier container 40 by the action of the liquid-containing combined container 10L to adjust the amount of oxygen in the container 30.

The stopper 34 may have an oxygen permeation amount of 2 (cm³/(day·atm)) or more. The stopper 34 may have an oxygen permeation amount of 2.2 (cm³/(day·atm)) or more, 2.4 (cm³/(day·atm)) or more, or 2.9 (cm³/(day·atm)) or more. When the stopper 34 has an oxygen permeation amount in such a range, the amount of oxygen in the container 30 can be efficiently adjusted by oxygen permeation through the stopper 34.

The predetermined oxygen permeation amount may be 100 (cm³/(day·atm)) or less, 50 (cm³/(day·atm)) or less, or 10 (cm³/(day·atm)) or less. Setting the upper limit of the oxygen permeation amount can suppress the leakage of water vapor or the like and can suppress the influence on the liquid in the container 30 after the opening of the barrier container 40 due to a high oxygen permeation velocity. The range of the oxygen permeation amount may be defined by combining the lower limit of the oxygen permeation amount with the upper limit of the oxygen permeation amount.

The oxygen permeation amount (cm³/(day·atm)) through a portion of the container, such as the stopper 34 of the container 30, may be measured using a test container 70 containing the portion, as illustrated in FIG. 2B. The test container 70 includes a partition wall portion 71. The test container 70 has an internal space defined by the partition wall portion 71. The partition wall portion 71 includes a portion of the container and a main wall portion 72 with an oxygen barrier property. The permeation amount of a portion of the container is defined as the oxygen permeation amount (cm³/(day·atm)) of the test container 70.

The concentration of oxygen in the test container 70 is maintained, for example, at 0.05% or less. The test container 70 is connected to a first flow path 76 and a second flow path 77. The second flow path 77 is connected to an oxygen meter 79 to measure the amount of oxygen. The oxygen meter 79 can measure the amount of oxygen (mL) flowing through the second flow path 77. The oxygen meter 79 may be an oxygen content meter used in OXTRAN (2/61) manufactured by MOCON, Inc., U.S.A. A gas is supplied to the test container 70 through the first flow path 76. A gas not containing oxygen may be supplied through the first flow path 76. An inert gas may be supplied through the first flow path 76. Nitrogen may be supplied through the first flow path 76. A gas in the test container 70 is discharged through the second flow path 77. The first flow path 76 and the second flow path 77 maintain the inside of the test container 70 in a state where oxygen is not substantially present. The concentration of oxygen in the test container 70 may be maintained at 0.05% or less, less than 0.03%, or 0%.

The test container 70 is placed in a test atmosphere with a temperature of 23° C. and a humidity of 40% RH. The concentration of oxygen in the atmosphere in which the test container 70 is placed is higher than the concentration of oxygen in the test container 70. The test atmosphere may be an air atmosphere. The concentration of oxygen in the air atmosphere is 20.95%. When the test container 70 is placed in the test atmosphere, oxygen is transferred from the test atmosphere into the test container 70 through a portion 30X of the container. The gas in the test container 70 is discharged through the second flow path 77. The amount of oxygen flowing through the second flow path 77 can be measured with the oxygen meter 79 to measure the oxygen permeation amount through the portion 30X per day (cm³/(day·atm)) in the atmosphere with a temperature of 23° C. and a humidity of 40% RH.

In the illustrated example, the test container 70 is placed in a test chamber 78. The atmosphere in the test chamber 78 is maintained at a temperature of 23° C. and a humidity of 40% RH. Air is supplied to the test chamber 78 through a supply path 78A. The gas in the test chamber 78 is discharged through a discharge path 78B. The air is circulated through the supply path 78A and the discharge path 78B, and the concentration of oxygen in the test chamber 78 is maintained at 20.95%.

In the example illustrated in FIG. 2B, a pump for circulating air may be provided in one of the supply path 78A and the discharge path 78B. In the example illustrated in FIG. 2B, the supply path 78A and the discharge path 78B may be opened to an air atmosphere at atmospheric pressure. The test container 70 may not be placed in the test chamber 78. The test container 70 may be placed in an air atmosphere at atmospheric pressure without the test chamber 78.

FIG. 2B illustrates a method for measuring the oxygen permeation amount in the portion 30X with oxygen permeability of the container 30 as an example. In the example illustrated in FIG. 2B, the partition wall portion 71 is constituted by the portion 30X with oxygen permeability of the container 30 and the main wall portion 72 with an oxygen barrier property. For example, the partition wall portion 71 may be constituted by the portion 30X cut out from the container 30 and by the main wall portion 72 connected to a peripheral portion of the portion 30X. The main wall portion 72 has a through-hole 72A through which the portion 30X is exposed. A peripheral portion of the through-hole 72A and a portion 30Y adjacent to the portion 30X may be hermetically joined. In the illustrated example, the portion 30Y adjacent to the portion 30X is hermetically joined to the peripheral portion of the through-hole 72A of the main wall portion 72 via a barrier joint material 73. In the example illustrated in FIG. 2B, the vicinity of the stopper 34 of the container 30 illustrated in FIG. 2A is cut off. This makes it possible to measure the oxygen permeation amount of the stopper 34 as the portion 30X with oxygen permeability. Portions 32c and 32d forming the opening portion 33 of the container body 32 and the fixture 36 are hermetically connected to the main wall portion 72 via the barrier joint material 73 as the portion 30Y adjacent to the portion 30X with oxygen permeability.

In the example illustrated in FIG. 2B, the container body 32 is cut at a neck 32c. The stopper 34 is held in compression within the opening portion 33 formed by a head 32d of the container body 32. The fixture 36 hermetically seals the space between the container body 32 and the stopper 34. The fixture 36 with an oxygen barrier property, such as aluminum, partially covers the stopper 34. The container body 32 and the fixture 36 with the oxygen barrier property are connected to the main wall portion 72 via the barrier joint material 73. The stopper 34 is maintained in a state similar to the state of the container 30 closed in actual use by compression in the opening portion 33, pressing by the fixture 36, or the like. Thus, the oxygen permeation amount of the stopper 34 can be measured under the same conditions as in actual use.

To measure the oxygen permeation amount (cm³/(day·atm)) of the stopper 34 of the container 30 as a portion of the container 30, as illustrated in FIG. 2C, it can also be measured using the test container 70 including the stopper 34. The test container 70 illustrated in FIG. 2C and a method for measuring the oxygen permeation amount using the test container 70 illustrated in FIG. 2C are described below with a focus on differences from the test container 70 illustrated in FIG. 2B and a method for measuring the oxygen permeation amount using the test container 70 illustrated in FIG. 2B. In FIG. 2C, portions that can be configured similarly to those of the test container 70 illustrated in FIG. 2B are denoted by the same reference numerals and letters as those used for the test container 70 illustrated in FIG. 2B, and redundant description may be omitted. Furthermore, when it is clear that the operation and effect obtained with the test container 70 illustrated in FIG. 2B can also be obtained with the test container 70 illustrated in FIG. 2C, the description thereof may be omitted.

In FIG. 2C, the portion 30X of the container 30 is the stopper 34. The portions 32c and 32d forming the opening portion 33 of the container body 32 and the fixture 36 are not arranged in the test chamber 78. In FIG. 2C, the stopper 34 is hermetically joined to a peripheral portion of the through-hole 72A of the main wall portion 72 via the barrier joint material 73. This makes it possible to measure the oxygen permeation amount of the stopper 34 as the portion 30X with oxygen permeability.

A method for measuring the oxygen permeation amount (cm³/(day·atm)) of a portion of the container, such as the stopper 34 of the container 30, can be a measurement method using the test container 70 illustrated in FIG. 2C when the measurement object is the stopper 34. The measurement method using the test container 70 illustrated in FIG. 2B can be adopted when the measurement object is other than the stopper 34 or in a situation where the measurement method using the test container 70 illustrated in FIG. 2C is undesirable even when the measurement object is the stopper 34.

The method for measuring the oxygen permeation amount (cm³/(day·atm)) of a portion of the container (cm³/(day·atm)) has been described above. The oxygen permeation amount (cm³/(day·atm)) of the entire container can be determined by dividing the container into two or more portions and summing the oxygen permeation amount measured for each portion. For example, the oxygen permeation amount of the container 30 illustrated in FIG. 2 can be determined by measuring the oxygen permeation amount of the container body 32 and summing the oxygen permeation amount of the container body 32 and the oxygen permeation amount of the portion 30X measured by the method illustrated in FIG. 2B. The oxygen permeation amount (cm³/(day·atm)) of the container body 32 can be measured using the test container 70 produced by combining the container body 32 with the main wall portion 72.

The total oxygen permeation amount of the container 30 including the container body 32 and the stopper 34 is, for example, 0.9 (cm³/(day·atm)) or more. When the oxygen permeation amount of the container 30 is in this range, the amount of oxygen in the container 30 can be efficiently adjusted by oxygen permeation through the container 30.

The stopper 34 may be permeable to all gases. The stopper 34 may be permeable to only some gases including oxygen, for example, only oxygen.

A material constituting the stopper 34, for example, a material constituting the stopper body portion 35, may have an oxygen permeability coefficient of 5.0×10⁴ (cm³·20 μm/(m²·day·atm)) or more, 2.4×10⁵ (cm³·20 μm/(m²·day·atm)) or more, or 5.0×10⁵ (cm³·20 μm/(m²·day·atm)) or more. When the stopper 34 has a plurality of layers, a material constituting at least one layer may have such an oxygen permeability coefficient, or a material constituting all the layers may have the oxygen permeability coefficient. Setting the lower limit of the oxygen permeability coefficient promotes oxygen permeation through the stopper 34 and allows the concentration of oxygen in the container 30 to be rapidly adjusted. When the stopper 34 has a plurality of layers, a material constituting at least one layer may have such a permeability coefficient, or a material constituting all the layers may have the permeability coefficient.

In the present description, when a measurement object for the oxygen permeability coefficient is a resin film or a resin sheet, the oxygen permeability coefficient is a value measured in accordance with JIS K 7126-1. When the measurement object is rubber, the oxygen permeability coefficient is a value measured in accordance with JIS K 6275-1. The oxygen permeability coefficient is a value measured in an environment with a temperature of 23° C. and a humidity of 40% RH using a permeability measuring instrument OXTRAN (2/61) manufactured by MOCON, Inc., U.S.A.

From the perspective of promoting oxygen transfer from the inside of the container 30 to the outside of the container 30, the stopper 34 with oxygen permeability is preferably not in contact with the liquid L. In the container including the container body 32 and the stopper 34, typically, the stopper 34 is separated from the liquid L in the container body 32. Thus, in a typical storage state of the container 30, oxygen permeation through the stopper 34 of the container 30 can be promoted.

A material constituting the stopper 34, for example, a material constituting the stopper body portion 35, may have a higher oxygen permeability coefficient than a material constituting the container body 32. Furthermore, a portion of the stopper 34 may have oxygen permeability. A portion of the stopper 34 may be constituted by a material with oxygen permeability through its entire thickness. For example, the stopper 34 may have oxygen permeability through the entire thickness thereof in a central portion apart from the periphery thereof and have an oxygen barrier property in a peripheral portion surrounding the central portion.

For example, the configuration of the portion with oxygen permeability of the container 30 may be determined such that the concentration of oxygen (%) in the container 30 can be reduced by 5% or more by storing the container 30 containing a liquid with a dissolved oxygen amount of 8 mg/L in the barrier container 40 for 4 weeks.

In the illustrated example, the area of the opening formed by the opening portion 33 (also referred to as the opening area of the opening portion 33) is preferably 1 mm² or more, more preferably 10 mm² or more, still more preferably 30 mm² or more. The stopper 34 has a thickness of, for example, 4 mm or less. The stopper 34 may have a thickness of 3.5 mm or less. The stopper 34 may have a thickness of 3.3 mm or less. The stopper 34 preferably has a thickness of 3 mm or less, more preferably 1 mm or less. These promote oxygen permeation through the container 30 and allow the concentration of oxygen in the container 30 to be rapidly adjusted. Furthermore, a syringe needle can puncture the stopper 34. Furthermore, from the perspective of enabling a straw to puncture a stopper, the stopper, for example, a film-like stopper, may have a thickness of several tenths of a millimeter or less.

The opening portion 33 may have an opening area of 5000 mm² or less. The stopper 34 may have a thickness of 0.01 mm or more. These can suppress the leakage of water vapor or the like and can suppress the influence on the liquid in the container 30 after the opening of the barrier container 40 due to a high oxygen permeation velocity. Furthermore, the stopper 34 with a thickness of 0.01 mm or more can have sufficient strength. The range of the opening area of the opening portion 33 may be determined by combining the upper limit of the opening area of the opening portion 33 with any lower limit of the opening area of the opening portion 33 described above. The range of the thickness of the stopper 34 may be determined by combining the lower limit of the thickness of the stopper 34 with any upper limit of the thickness of the stopper 34 described above.

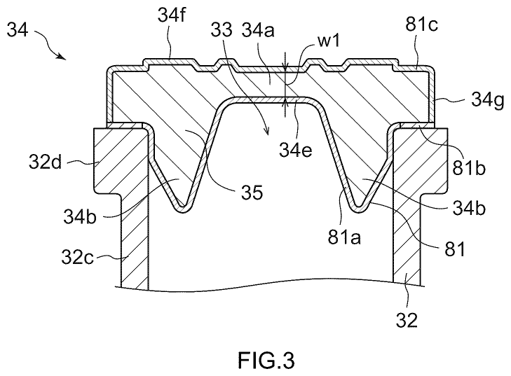

FIG. 3 is a view of an example of a cross section of a portion around the stopper 34 and the opening portion 33 of the container body 32. The stopper 34 illustrated in FIG. 3 includes a plate-like portion 34a with a plate shape and a tubular portion 34b extending from the plate-like portion 34a. The plate-like portion 34a has a first surface 34e, a second surface 34f opposite the first surface 34e, and a side surface 34g connecting the first surface 34e and the second surface 34f. The first surface 34e of the plate-like portion 34a faces the container body 32. The tubular portion 34b extends from the first surface 34e of the plate-like portion 34a. The tubular portion 34b is, for example, cylindrical. The tubular portion 34b is inserted into the opening portion 33. The plate-like portion 34a has a flange portion extending radially outward from the tubular portion 34b. The flange portion of the plate-like portion 34a is in contact with an end portion of the opening portion 33 formed by the head 32d of the container body 32.

The shape of the stopper 34 with oxygen permeability is not limited to the shape illustrated in FIG. 3. For example, the stopper 34 may have an outer spiral or an inner spiral. In such a case, the stopper 34 may be attached to the container body 32 by helical engagement.

As illustrated in FIG. 3, the stopper 34 is inserted into the opening portion 33 of the container body 32 to close the opening portion 33. The stopper 34 includes the stopper body portion 35 and the barrier layer 81 provided on at least part of the surface of the stopper body portion 35.

The stopper body portion 35 is described below. The stopper body portion 35 may contain silicone. For example, the stopper body portion 35 is formed only of silicone. A portion of the stopper body portion 35 may be formed of silicone. The silicone in the stopper body portion 35 is solid in an environment in which the container 30 is to be used. The silicone in the stopper body portion 35 may not a contain silicone that is liquid in a room temperature environment, such as silicone oil. Silicone is a substance with a siloxane bond as a main chain. The stopper body portion 35 may be formed of a silicone elastomer. The stopper body portion 35 may be formed of a silicone rubber. The silicone rubber refers to a rubber-like material composed of silicone. The silicone rubber is a synthetic resin composed mainly of silicone and is a rubber-like substance. The silicone rubber is a rubber-like substance with a siloxane bond as a main chain. The silicone rubber may be a thermosetting compound with a siloxane bond. The silicone rubber is, for example, a methyl silicone rubber, a vinyl-methyl silicone rubber, a phenyl-methyl silicone rubber, a dimethyl silicone rubber, a fluorosilicone rubber, or the like.

The stopper body portion 35 containing silicone can have a higher oxygen permeation amount. The silicone and the silicone rubber have an oxygen permeability coefficient of 5.0×10⁴ (cm³·20 μm/(m²·day·atm)) or more, even 5.0×10⁵ (cm³·20 μm/(m²·day·atm)) or more. The silicone and the silicone rubber have an oxygen permeability coefficient of 5.0×10⁷ (cm³·20 μm/(m²·day·atm)) or less. The silicone rubber has an oxygen permeability coefficient of, for example, approximately 1.0×10⁶ (cm³·20 μm/(m²·day·atm)). The silicone and the silicone rubber have a hydrogen permeability coefficient approximately 10 times that of natural rubber, an oxygen permeability coefficient approximately 20 times that of natural rubber, and a nitrogen permeability coefficient approximately 30 times that of natural rubber. The silicone and the silicone rubber have a hydrogen permeability coefficient at least 70 times that of butyl rubber, an oxygen permeability coefficient at least 40 times that of butyl rubber, and a nitrogen permeability coefficient at least 650 times that of butyl rubber.

At least a portion of the stopper body portion 35 may be composed of silicone. More specifically, the whole or part of the stopper body portion 35 may be composed of silicone or a silicone rubber. For example, a portion of the stopper body portion 35 may be composed of silicone or a silicone rubber over the entire thickness thereof. The portion may be a central portion of the stopper body portion 35 or part or all of a peripheral portion surrounding the central portion.

The barrier layer 81 is described below. The barrier layer 81 is provided on at least part of the surface of the stopper body portion 35. In the example illustrated in FIG. 3, the barrier layer 81 covers the entire surface of the stopper body portion 35.

The barrier layer 81 constitutes at least a surface of a portion of the stopper 34 to be inserted into the container body 32 and a surface of the stopper 34 defining a storage space for the liquid L. As described above, the tubular portion 34b of the stopper 34 illustrated in FIG. 3 is inserted into the opening portion 33. The barrier layer 81 constitutes a surface of the tubular portion 34b. Thus, the barrier layer 81 constitutes the surface of the portion of the stopper 34 to be inserted into the container body 32. Furthermore, part of the surface of the tubular portion 34b and a portion of the first surface 34e of the plate-like portion 34a located radially inside the tubular portion 34b define the storage space for the liquid L together with the inner surface of the container body 32. The barrier layer 81 constitutes the surface of the tubular portion 34b and the portion of the first surface 34e of the plate-like portion 34a located radially inside the tubular portion 34b. Thus, the barrier layer 81 constitutes the surface defining the storage space for the liquid L. A portion of the barrier layer 81 that constitutes the surface of the portion of the stopper 34 to be inserted into the container body 32 and the surface of the stopper 34 defining the storage space for the liquid L is referred to as a first portion 81a.

In the example illustrated in FIG. 3, the barrier layer 81 constitutes a surface of the stopper 34 in contact with the end portion of the opening portion 33 of the container body 32. As described above, the flange portion of the plate-like portion 34a illustrated in FIG. 3 is in contact with the end portion of the opening portion 33 of the container body 32. In other words, a portion of the first surface 34e of the plate-like portion 34a located radially outside the tubular portion 34b is in contact with the end portion of the opening portion 33 of the container body 32. The barrier layer 81 constitutes the portion of the first surface 34e of the plate-like portion 34a located radially outside the tubular portion 34b. Thus, the barrier layer 81 constitutes the surface of the stopper 34 in contact with the end portion of the opening portion 33 of the container body 32. The portion of the barrier layer 81 in contact with the end portion of the opening portion 33 of the container body 32 is referred to as a second portion 81b.

In the example illustrated in FIG. 3, the barrier layer 81 constitutes a surface of the stopper 34 that forms the outer surface of the liquid-containing container 30L. In the example illustrated in FIG. 3, the second surface 34f and the side surface 34g of the plate-like portion 34a form the outer surface of the liquid-containing container 30L. The barrier layer 81 constitutes the second surface 34f and the side surface 34g of the plate-like portion 34a. A portion of the barrier layer 81 that forms the outer surface of the liquid-containing container 30L is referred to as a third portion 81c.

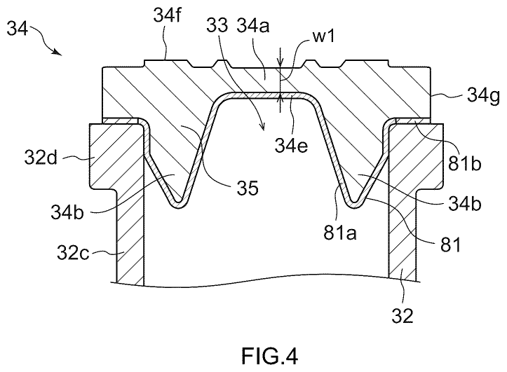

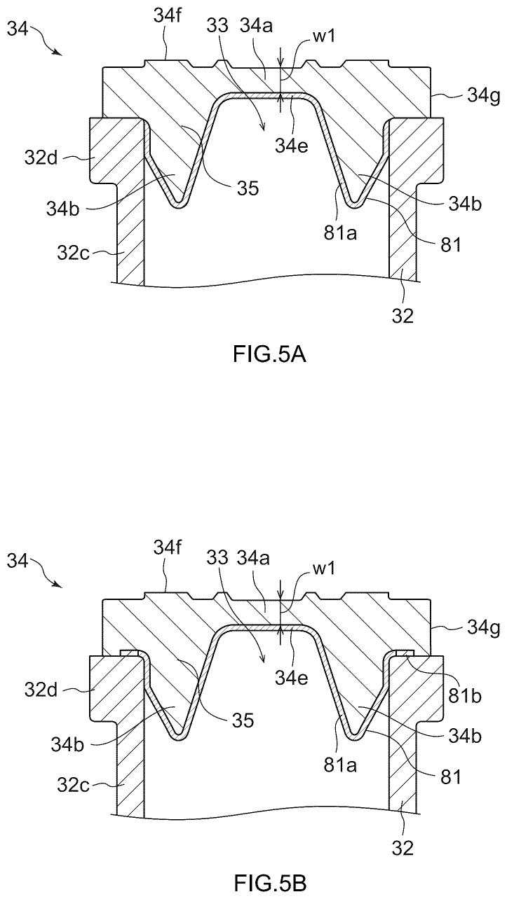

FIG. 4 is a view of another example of a cross section of a portion around the stopper 34 and the opening portion 33 of the container body 32, which is different from the example illustrated in FIG. 3. FIG. 5A is a view of another example of a cross section of a portion around the stopper 34 and the opening portion 33 of the container body 32, which is different from the examples illustrated in FIGS. 3 and 4. FIG. 5B is a view of another example of a cross section of a portion around the stopper 34 and the opening portion 33 of the container body 32, which is different from the examples illustrated in FIGS. 3, 4, and 5A. As illustrated in FIGS. 4, 5A, and 5B, the barrier layer 81 may not include the third portion 81c. Furthermore, as illustrated in FIGS. 5A and 5B, the barrier layer 81 may not have part or the whole of the second portion 81b.

The barrier layer 81 constituting at least the surface of the portion of the stopper 34 to be inserted into the container body 32 and the surface of the stopper 34 defining the storage space for the liquid L has the following effects. A portion of the stopper body portion 35 with which the liquid L in the container 30 can come into contact is covered with the barrier layer 81. This can suppress the contact between the liquid L and a material of the stopper body portion 35. This can suppress degradation of the liquid L due to a reaction with a material of the stopper body portion 35. In particular, when the stopper body portion 35 contains a silicone rubber, a highly active substance derived from a rubber vulcanizing agent or an additive agent, such as a stabilizer or an antioxidant, may be eluted from the stopper body portion 35. Such an eluate may cause degradation of the liquid L in the container 30. In such a case, the barrier layer 81 can suppress the degradation of the liquid L caused by the eluate from the stopper body portion 35. Furthermore, a component in the liquid L may aggregate by coming into contact with a material of the stopper body portion 35. In such a case, the barrier layer 81 can suppress the aggregation of a component in the liquid L by contact with a material of the stopper body portion 35. The stopper 34 that includes the barrier layer 81 and has oxygen permeability can suppress a reaction of the liquid L in the container 30 with a material of the stopper 34 and allows oxygen in the container 30 to be discharged to the outside of the container 30 through the stopper 34.

The barrier layer 81 also provides the following effects. As described above, the liquid L may be a chemical. In particular, the liquid L may be a biopharmaceutical (antibody preparation). In such a case, a biopharmaceutical as the liquid L may react with a material of the stopper body portion 35 and may be degraded. In particular, when the stopper body portion 35 contains a silicone rubber, the silicone rubber may adsorb and decrease a component of a biopharmaceutical. Furthermore, when the biopharmaceutical comes into contact with the silicone rubber, a component of the biopharmaceutical may aggregate due to the silicone rubber. For example, in a biopharmaceutical composed mainly of a monomer, the monomer may aggregate due to the silicone rubber. This can reduce the effectiveness of the biopharmaceutical. The barrier layer 81 suppresses the contact between the liquid L and a material of the stopper body portion 35. This can suppress degradation of the biopharmaceutical as the liquid L due to a reaction with a material of the stopper body portion 35. The biopharmaceutical is, for example, infliximab or bevacizumab.

As described above, in the examples illustrated in FIGS. 4, 5A, and 5B, the barrier layer 81 does not have the third portion 81c. In the examples illustrated in FIGS. 4, 5A, and 5B, the stopper body portion 35 constitutes the surface of the stopper 34 that forms the outer surface of the liquid-containing container 30L. In the examples illustrated in FIGS. 4, 5A, and 5B, the second surface 34f and the side surface 34g of the plate-like portion 34a form the outer surface of the liquid-containing container 30L. The stopper body portion 35 constitutes the second surface 34f and the side surface 34g of the plate-like portion 34a.

The stopper body portion 35 constituting the surface of the stopper 34 that forms the outer surface of the liquid-containing container 30L can have the following effects. When the barrier layer 81 constitutes the surface of the stopper 34 that forms the outer surface of the liquid-containing container 30L, oxygen in the container 30 must permeate the barrier layer 81 twice before being discharged to the outside of the container 30. In contrast, when the stopper body portion 35 constitutes the surface of the stopper 34 that forms the outer surface of the liquid-containing container 30L, oxygen in the container 30 can be discharged to the outside of the container 30 by permeating the barrier layer 81 once. Thus, oxygen in the container 30 can be more easily discharged to the outside of the container 30.

In the example illustrated in FIG. 5A, the barrier layer 81 does not have the entire second portion 81b. In the example illustrated in FIG. 5A, the stopper body portion 35 constitutes the entire surface of the stopper 34 in contact with the end portion of the opening portion 33 of the container body 32. In the example illustrated in FIG. 5A, the portion of the first surface 34e of the plate-like portion 34a located radially outside the tubular portion 34b is in contact with the end portion of the opening portion 33 of the container body 32. The stopper body portion 35 constitutes the entire portion of the first surface 34e of the plate-like portion 34a located radially outside the tubular portion 34b.

In the example illustrated in FIG. 5B, the barrier layer 81 does not have a portion of the second portion 81b. In the example illustrated in FIG. 5B, the stopper body portion 35 constitutes a radially outer portion of the surface of the stopper 34 in contact with the end portion of the opening portion 33 of the container body 32. In the example illustrated in FIG. 5B, the portion of the first surface 34e of the plate-like portion 34a located radially outside the tubular portion 34b is in contact with the end portion of the opening portion 33 of the container body 32. The stopper body portion 35 constitutes part of the portion of the first surface 34e of the plate-like portion 34a located radially outside the tubular portion 34b.

In the stoppers 34 illustrated in FIGS. 5A and 5B, the stopper body portion 35 is in contact with the end portion of the opening portion 33 of the container body 32 to close the opening portion 33 so as to seal the liquid L. In the stoppers 34 illustrated in FIGS. 5A and 5B, the stopper body portion 35 comes into contact with the end portion of the opening portion 33 of the container body 32 and hermetically seals the container 30. The stopper body portion 35 in the stopper 34 illustrated in FIG. 5A or 5B is in contact with the end portion of the opening portion 33 in the annular region along the end portion of the opening portion 33. In other words, the stopper body portion 35 of the stopper 34 illustrated in FIG. 5A or 5B is in contact with the end portion of the opening portion 33 in a region surrounded by two closed curves that do not intersect with each other.

The stopper body portion 35 constituting the surface of the stopper 34 in contact with the end portion of the opening portion 33 of the container body 32 can have the following effects. When the stopper 34 comes into contact with the end portion of the opening portion 33 of the container body 32, the stopper 34 comes into close contact with the end portion of the opening portion 33 and seals the container 30 with the liquid L, thereby preventing leakage of the liquid L from the container 30. In the present embodiment, the stopper 34 is pressed against the end portion of the opening portion 33 by the fixture 36 as described later and is brought into close contact with the end portion of the opening portion 33. Here, when the surface of the stopper 34 in contact with the end portion of the opening portion 33 is constituted by the stopper body portion 35, the stopper 34 is brought into close contact with the end portion of the opening portion 33 with a smaller gap as compared with the case where the surface is constituted by the barrier layer 81. This can more securely seal the container 30 with the liquid L and more effectively prevent leakage of the liquid L from the container 30. In particular, when the stopper body portion 35 comes into contact with the end portion of the opening portion 33 in the annular region along the end portion of the opening portion 33, the stopper 34 can be brought into close contact with the end portion of the opening portion 33 with a smaller gap and more effectively prevent leakage of the liquid L from the container 30.

The barrier layer 81 includes at least one selected from the group consisting of a p-xylylene layer, a diamond-like carbon layer, and a fluoropolymer layer. p-Xylylene, diamond-like carbon, and a fluoropolymer are highly biocompatible materials. In other words, these are materials that do not provide adverse effects or a strong stimulus to a living body, such as a human body. Thus, even when the container 30 contains, as the liquid L, a liquid to be taken into a living body, such as food or a chemical, it is possible to effectively suppress the barrier layer 81 from adversely affecting the liquid L.

When the barrier layer 81 includes a p-xylylene layer, the p-xylylene layer contains poly(p-xylylene). The poly(p-xylylene) in the p-xylylene layer is, for example, poly(p-xylylene) in which an aromatic ring and a methylene group are not substituted with a functional group. The poly(p-xylylene) may be a material in which a functional group is introduced into an aromatic ring or a methylene group. For example, the poly(p-xylylene) may be poly(chloro p-xylylene) in which an aromatic ring is substituted with chlorine, poly(methyl p-xylylene) in which an aromatic ring is substituted with a methyl group, poly(fluoro p-xylylene) in which a methylene group is substituted with fluorine, or the like. The poly(p-xylylene) is not limited to a homopolymer composed only of poly(p-xylylene). The poly(p-xylylene) may be a copolymer of a p-xylylene monomer and a copolymerizable monomer. The poly(p-xylylene) is particularly preferably poly(p-xylylene) or poly(chloro p-xylylene) in which an aromatic ring and a methylene group are not substituted with a functional group. The p-xylylene layer may be formed of a single layer of the poly(p-xylylene) or copolymer or may be formed of multiple layers of the poly(p-xylylene) and/or copolymer. In the present description, the poly(p-xylylene) is not limited to poly(p-xylylene) in which an aromatic ring and a methylene group are not substituted with a functional group. The poly(p-xylylene) in the present description includes a material in which a functional group is introduced into an aromatic ring, such as the poly(chloro p-xylylene) or the poly(methyl p-xylylene) described above. Furthermore, the poly(p-xylylene) in the present description includes a material in which a functional group is introduced into a methylene group, such as the poly(fluoro p-xylylene) described above.

Poly(p-xylylene) in which an aromatic ring and a methylene group are not substituted with a functional group is, for example, p-xylylene N. Poly(chloro p-xylylene) in which an aromatic ring is substituted with chlorine is, for example, p-xylylene C. The poly(fluoro p-xylylene) is, for example, p-xylylene HT.

For example, the p-xylylene layer in the barrier layer 81 is a multilayer film formed by the following method. First, a p-xylylene dimer represented by the following chemical formula (1) is thermally decomposed to produce a p-xylylene monomer. The p-xylylene monomer is then polymerized to form a multilayer film. When the p-xylylene layer is the multilayer film, the p-xylylene layer is a layer with a stable thickness without a pinhole.

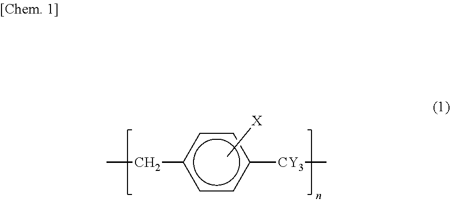

(X: H, Cl, or CH₃, Y: H or F)

A method for forming a p-xylylene layer on the stopper body portion 35 is described below. For example, the p-xylylene layer is formed by polymerizing a p-xylylene monomer represented by the chemical formula (1) on the stopper body portion 35. The p-xylylene layer may be formed on the stopper body portion 35 by vacuum deposition. The p-xylylene layer may be formed on the stopper body portion 35 by chemical vapor deposition, a sputtering method, an ion plating method, or the like. In particular, polymerization of poly (p-xylylene) and film formation are simultaneously performed by chemical vapor deposition on the stopper body portion 35 using a p-xylylene monomer. A p-xylylene layer with a uniform thickness can be formed by chemical vapor deposition.

In the barrier layer 81 including a diamond-like carbon layer, the diamond-like carbon layer contains diamond-like carbon (DLC). The diamond-like carbon layer may be formed on the stopper body portion 35, for example, by a vapor deposition method, such as chemical vapor deposition or physical vapor deposition.

In the barrier layer 81 including a fluoropolymer layer, the fluoropolymer layer may contain a perfluoroalkoxy alkane (PFA). The fluoropolymer layer may contain a perfluoroethylene propene copolymer (FEP). The fluoropolymer layer may contain an ethylene tetrafluoroethylene copolymer (ETFE)). The fluoropolymer layer may contain an amorphous fluoropolymer. The fluoropolymer layer may be formed on the stopper body portion 35 by any method. From the perspective of reducing the thickness of the barrier layer 81 so that the barrier layer 81 does not significantly hinder oxygen permeation, a method for forming the fluoropolymer layer on the stopper body portion 35 is preferably a method other than a lamination method of applying a fluoropolymer film to the stopper body portion 35. The fluoropolymer layer may be formed on the stopper body portion 35 by coating. More specifically, the fluoropolymer may be formed on the stopper body portion 35 by a spin coating method, a dip coating method, or the like. The fluoropolymer is a plastic containing a fluorine atom.

A material of the stopper 34, particularly a material of the barrier layer 81, is analyzed by infrared spectroscopy (IR). In this case, infrared spectroscopy (IR) may be combined with mass spectrometry (MS) to analyze the material.

The thicknesses of the stopper body portion 35 and the barrier layer 81 are described below. First, the thickness of the stopper body portion 35 is described below. For example, the stopper body portion 35 is a typical vial stopper composed of a silicone rubber. More specifically, a typical vial stopper may be used as the stopper body portion 35, and the barrier layer 81 may be formed on the stopper body portion 35 to produce the stopper 34 of the present embodiment. A typical vial stopper often has a thickness of 1.5 mm or more and 4 mm or less. A typical vial stopper has a thickness of, for example, 2 mm or more and 3.3 mm or less. When the stopper body portion 35 is a vial stopper with a thickness of 1.5 mm or more and 4 mm or less, the stopper body portion 35 also has a thickness of 1.5 mm or more and 4 mm or less. For example, when a typical vial stopper is used as the stopper body portion 35 illustrated in FIG. 3, the stopper body portion 35 has a thickness w1 of 1.5 mm or more and 4 mm or less. The thickness w1 of the stopper body portion 35 refers to the thickness in the direction in which the stopper 34 is inserted into the opening portion 33. When the thickness of the stopper body portion 35 is not constant, the thickness w1 refers to the minimum thickness of the portion of the stopper body portion 35 overlapping the opening portion 33. In FIGS. 3, 4, 5A, and 5B, the stopper 34 has the plate-like portion 34a. The portion of the stopper body portion 35 overlapping the opening portion 33 has the minimum thickness in the portion constituting the plate-like portion 34a. In this case, the thickness w1 corresponds to the thickness of a portion of the stopper body portion 35 that constitutes the plate-like portion 34a and is located radially inside the tubular portion 34b.

The thickness w1 of the stopper body portion 35 may be adjusted so as to increase the oxygen permeation amount of the stopper 34. For example, the thickness w1 of the stopper body portion 35 is adjusted so that the stopper 34 has the oxygen permeability described above.

The present inventors have found that a typical vial stopper, particularly a typical vial stopper with a thickness of 1.5 mm or more and 4 mm or less composed of a silicone rubber, has a sufficiently high oxygen permeation amount. In particular, it has been found that a typical vial stopper with a thickness of 1.5 mm or more and 4 mm or less composed of a silicone rubber has the oxygen permeability described above. On the other hand, when a typical vial stopper is used as the stopper body portion 35 and the barrier layer 81 is formed on the stopper body portion 35 to produce the stopper 34, the oxygen permeation amount of the stopper 34 is considered to be lower than the oxygen permeation amount of the typical vial stopper due to the barrier layer 81. Thus, to adjust the thickness w1 of the stopper body portion 35, the thickness w1 of the stopper body portion 35 is preferably reduced so that the oxygen permeation amount of the stopper 34 is not much lower than the oxygen permeation amount of a typical vial stopper due to the barrier layer 81. For example, the thickness w1 of the stopper body portion 35 of the stopper 34 of the present embodiment is adjusted to be smaller than the thickness of a typical vial stopper. In particular, the thickness w1 of the stopper body portion 35 is preferably adjusted to be smaller than the thickness of a typical vial stopper so that the oxygen permeation amount of the stopper 34 is equal to or higher than the oxygen permeation amount of the typical vial stopper.

In the stopper 34 of the present embodiment, however, the thickness w1 of the stopper body portion 35 is not necessarily adjusted. The stopper 34 with a sufficiently high oxygen permeation amount can be used as the stopper 34 of the present embodiment without limitation. As described above, a typical vial stopper may be used as the stopper body portion 35 without adjusting the thickness.

Next, the thickness of the barrier layer 81 is described. The thickness of the barrier layer 81 is the total thickness of the barrier layer 81 through which oxygen in the container 30 permeates before being discharged to the outside of the container 30. The barrier layer 81 illustrated in FIG. 3 has the third portion 81c. In the container 30 provided with the stopper 34 illustrated in FIG. 3, oxygen in the container 30 is discharged to the outside of the container 30 through the first portion 81a and the third portion 81c. In the stopper 34 illustrated in FIG. 3, the thickness of the barrier layer 81 is the total thickness of the first portion 81a and the third portion 81c. The barrier layer 81 illustrated in FIGS. 4, 5A, and 5B does not have the third portion 81c. In the container 30 provided with the stopper 34 illustrated in FIGS. 4, 5A, and 5B, oxygen in the container 30 is discharged to the outside of the container 30 through the first portion 81a. In the stopper 34 illustrated in FIGS. 4, 5A, and 5B, the thickness of the barrier layer 81 is the thickness of the first portion 81a.

In the following case, the thickness w1 of the stopper body portion 35 is adjusted so that the oxygen permeation amount of the stopper 34 is not much lower than the oxygen permeation amount of a typical vial stopper, as described above. In this case, to ensure the stopper 34 adequately seals the liquid L, the thickness w1 of the stopper body portion 35 is preferably not reduced by more than 1 mm from the thickness of a typical vial stopper. When the thickness w1 of the stopper body portion 35 is not reduced by more than 1 mm from the thickness of a typical vial stopper, the following effects can be produced. When the stopper body portion 35 is formed by reducing the thickness of a typical vial stopper, and the barrier layer 81 is provided on the surface of the stopper body portion 35 to produce the stopper 34, this reduces the difference between the dimensions of the stopper before being formed into the stopper body portion 35 and the dimensions of the produced stopper 34. Thus, the opening portion of a vial that is distributed together with a stopper to be processed into the stopper body portion 35 can also be stably closed with the produced stopper 34.

The oxygen permeability of the barrier layer 81 is preferably equal to or higher than the oxygen permeability per millimeter of the thickness of a material of the stopper body portion 35. If the thickness w1 of the stopper body portion 35 is reduced by at least 1 mm from the thickness of a typical vial stopper, the total oxygen permeation amount of the stopper 34 is equal to or higher than the oxygen permeation amount of a typical vial stopper. Thus, the total oxygen permeation amount of the stopper 34 can be equal to or higher than the oxygen permeation amount of a typical vial stopper without greatly reducing the thickness w1 of the stopper body portion 35 by more than 1 mm.

The oxygen permeability per millimeter of the thickness of a material of the stopper body portion 35 can be expressed by α1·20/1000 (cm³/(m²·day·atm)) using the oxygen permeability coefficient α1 (cm³·20 μm/(m²·day·atm)) of the stopper body portion 35. The oxygen permeability of the barrier layer 81 can be expressed by α2·20/w2 (cm³/(m²·day·atm)) using the oxygen permeability coefficient α2 (cm³·20 μm/(m²·day·atm)) of the barrier layer 81 and the thickness w2 (μm) of the barrier layer 81. Thus, when the following formula (3) is satisfied, the oxygen permeability of the barrier layer 81 is equal to or higher than the oxygen permeability per millimeter of the thickness of a material of the stopper body portion 35.

$$[ Math . 3 ]$$

$$α1 \times 20 / 1000 \leq α2 \times 20 / w 2 \qquad formula ( 3 )$$

The formula (3) is rearranged into the following formula (2). Thus, when the thickness w2 of the barrier layer 81 is adjusted so that the following formula (2) is satisfied, the oxygen permeability of the barrier layer 81 can be equal to or higher than the oxygen permeability per millimeter of the thickness of a material of the stopper body portion 35.

$$[ Math . 4 ]$$

$$α1 / 1000 \leq α2 / w 2 \qquad formula ( 2 )$$

As described above, the thickness w1 of the stopper body portion 35 is preferably not reduced by more than 1 mm from the thickness of a typical vial stopper. On the other hand, from the perspective of increasing the oxygen permeation amount of the stopper body portion 35, the stopper body portion 35 preferably has a small thickness w1. Thus, the thickness w1 of the stopper body portion 35 is particularly preferably smaller by 1 mm than the thickness of a typical vial stopper. From this perspective, considering that a typical vial stopper has a thickness of 1.5 mm or more and 4 mm or less, the stopper body portion 35 preferably has a thickness w1 of 0.5 mm or more and 3 mm or less.

For example, the barrier layer 81 is formed of a p-xylylene layer or a diamond-like carbon layer. In this case, the barrier layer 81 has a thickness of, for example, 100 nm or more. The barrier layer 81 may have a thickness of 200 nm or more. The barrier layer 81 has a thickness of, for example, 1200 nm or less. The barrier layer 81 may have a thickness of 1000 nm or less. The barrier layer 81 may have a thickness of less than 1000 nm. The barrier layer 81 may have a thickness of 500 nm or less. The barrier layer may have a thickness of 2000 nm or less.

When the lower limit of the thickness of the barrier layer 81 is set as described above and, in particular, when the barrier layer 81 has a thickness of 200 nm or more, the barrier layer 81 can more stably suppress the elution of an eluate from the stopper body portion 35 into the liquid L. Furthermore, a p-xylylene layer or a diamond-like carbon layer can be stably formed without causing pinholes or the like. Thus, the entire portion of the stopper body portion 35 with which the liquid L in the container 30 can come into contact can be stably covered with the barrier layer 81. This can stably suppress the contact between the liquid L and a material of the stopper body portion 35.

When the upper limit of the thickness of the barrier layer 81 is set as described above, the barrier layer 81 can have a sufficiently high oxygen permeation amount. This can sufficiently increase the total oxygen permeation amount of the stopper 34.

In particular, as described above, when the thickness w1 of the stopper body portion 35 is adjusted so that the oxygen permeation amount of the stopper 34 is not much lower than the oxygen permeation amount of a typical vial stopper, and when the upper limit of the thickness of the barrier layer 81 is set as described above, in particular, when the barrier layer 81 has a thickness of 1000 nm or less, the following effect is produced. As described above, the thickness w1 of the stopper body portion 35 is preferably not reduced by more than 1 mm from the thickness of a typical vial stopper. When the barrier layer 81 has a thickness of 1000 nm or less, the stopper 34 can have a sufficiently high total oxygen permeation amount without greatly reducing the thickness w1 of the stopper body portion 35 by more than 1 mm from the thickness of a typical vial stopper. This can produce the sufficient effect of the stopper 34 sealing the liquid L and sufficiently increase the total oxygen permeation amount of the stopper 34.

When the stopper body portion 35 is composed of a silicone rubber, the stopper body portion 35 has an oxygen permeability coefficient α1 of, for example, approximately 1.0×10⁶ (cm³·20 μm/(m²·day·atm)). When the barrier layer 81 is a p-xylylene layer composed of p-xylylene HT, the barrier layer 81 has an oxygen permeability coefficient α2 of, for example, approximately 1.0×10³ (cm³·20 μm/(m²·day·atm)). The oxygen permeability of a p-xylylene layer with a thickness of 1200 nm composed of p-xylylene HT is equal to or higher than the oxygen permeability of the stopper body portion 35 with a thickness w1 of 1 mm composed of a silicone rubber. Thus, when the stopper body portion 35 is composed of a silicone rubber and the barrier layer 81 is a p-xylylene layer composed of p-xylylene HT, the barrier layer 81 with a thickness of 1200 nm or less satisfies the formula (2). Thus, when the barrier layer 81 is a p-xylylene layer composed of p-xylylene HT, the barrier layer 81 with a thickness of 1200 nm or less produces the following effect. If the thickness w1 of the stopper body portion 35 is reduced by at least 1 mm from the thickness of a typical vial stopper, the total oxygen permeation amount of the stopper 34 is equal to or higher than the oxygen permeation amount of a typical vial stopper. Thus, the total oxygen permeation amount of the stopper 34 can be equal to or higher than the oxygen permeation amount of a typical vial stopper without greatly reducing the thickness w1 of the stopper body portion 35 by more than 1 mm.

When the barrier layer 81 is a p-xylylene layer composed of p-xylylene N, the barrier layer 81 has an oxygen permeability coefficient α2 of, for example, 7.5×10² (cm³·20 μm/(m²·day·atm)). The oxygen permeability of a p-xylylene layer with a thickness of 500 nm composed of p-xylylene N is equal to or higher than the oxygen permeability of the stopper body portion 35 with a thickness w1 of 1 mm composed of a silicone rubber. Thus, when the stopper body portion 35 is composed of a silicone rubber and the barrier layer 81 is a p-xylylene layer composed of p-xylylene N, the barrier layer 81 with a thickness of 500 nm or less satisfies the formula (2). Thus, when the barrier layer 81 is a p-xylylene layer composed of p-xylylene N, the barrier layer 81 with a thickness of 500 nm or less produces the following effect. If the thickness w1 of the stopper body portion 35 is reduced by at least 1 mm from the thickness of a typical vial stopper, the total oxygen permeation amount of the stopper 34 is equal to or higher than the oxygen permeation amount of a typical vial stopper. Thus, the total oxygen permeation amount of the stopper 34 can be equal to or higher than the oxygen permeation amount of a typical vial stopper without reducing the thickness w1 of the stopper body portion 35 by 1 mm or more.

Furthermore, when the upper limit of the thickness of the barrier layer 81 formed of a p-xylylene layer or a diamond-like carbon layer is set as described above and, in particular, when the barrier layer 81 has a thickness of 1000 nm or less, the following effect can be produced. From the perspective of stably suppressing the breakage of the stopper 34 and the formation of a hole in the stopper 34 and suppressing liquid leakage when the liquid-containing combined container 10L comes into contact with an external object, the stopper body portion 35 preferably has a thickness w1 of 0.5 mm or more. The barrier layer 81 with a thickness of 1000 nm or less can sufficiently increase the total oxygen permeation amount of the stopper 34 including the stopper body portion 35 with a thickness w1 of 0.5 mm and the barrier layer 81. This can produce the sufficient effect of the stopper 34 sealing the liquid L and sufficiently increase the total oxygen permeation amount of the stopper 34.

As illustrated in FIGS. 3 and 4, the barrier layer 81 may have the second portion 81b. In such a case, when the stopper 34 closes the opening portion 33, the barrier layer 81 constitutes the surface of the stopper 34 in contact with the end portion of the opening portion 33 of the container body 32. In this case, when the upper limit of the thickness of the barrier layer 81 composed of a p-xylylene layer or a diamond-like carbon layer is set as described above, the stopper 34 is brought into close contact with the end portion of the opening portion 33 with a smaller gap. This can more securely seal the container 30 with the liquid L and more effectively prevent leakage of the liquid L from the container 30.

In another example, the barrier layer 81 is composed of a fluoropolymer layer. In this case, the barrier layer 81 has a thickness of, for example, of 0.1 μm or more. The barrier layer 81 may have a thickness of 10 μm or more. The barrier layer 81 has a thickness of, for example, 50 μm or less. The barrier layer 81 may have a thickness of less than 50 μm. The barrier layer 81 may have a thickness of 21 μm or less. The barrier layer 81 may have a thickness of 20 μm or less.

When the lower limit of the thickness of the barrier layer 81 is set as described above, the barrier layer 81 can more stably suppress the elution of an eluate from the stopper body portion 35 into the liquid L. Furthermore, a fluoropolymer layer can be stably formed without causing pinholes or the like. Thus, the entire portion of the stopper body portion 35 with which the liquid L in the container 30 can come into contact can be stably covered with the barrier layer 81. This can stably suppress the contact between the liquid L and a material of the stopper body portion 35.

When the upper limit of the thickness of the barrier layer 81 is set as described above, the barrier layer 81 can have a sufficiently high oxygen permeation amount. This can sufficiently increase the total oxygen permeation amount of the stopper 34.

In particular, as described above, when the thickness w1 of the stopper body portion 35 is adjusted so that the oxygen permeation amount of the stopper 34 is not much lower than the oxygen permeation amount of a typical vial stopper, and when the upper limit of the thickness of the barrier layer 81 is set as described above, in particular, when the barrier layer 81 has a thickness of 50 μm or less, the following effect is produced. As described above, the thickness w1 of the stopper body portion 35 is preferably not reduced by more than 1 mm from the thickness of a typical vial stopper. When the barrier layer 81 has a thickness of 50 um or less, the total oxygen permeation amount of the stopper 34 can be sufficiently increased without greatly reducing the thickness w1 of the stopper body portion 35 by more than 1 mm from the thickness of a typical vial stopper. This can produce the sufficient effect of the stopper 34 sealing the liquid L and sufficiently increase the total oxygen permeation amount of the stopper 34.

In general, the oxygen permeability of a fluoropolymer layer with a thickness of 21 μm composed of an ethylene tetrafluoroethylene copolymer is equal to or higher than the oxygen permeability of the stopper body portion 35 with a thickness w1 of 1 mm composed of a silicone rubber. Thus, when the stopper body portion 35 is composed of a silicone rubber and the barrier layer 81 is a fluoropolymer layer composed of an ethylene tetrafluoroethylene copolymer, the barrier layer 81 with a thickness of 21 μm or less satisfies the formula (2). Thus, when the barrier layer 81 is a fluoropolymer layer composed of an ethylene tetrafluoroethylene copolymer, the barrier layer 81 with a thickness of 21 μm or less produces the following effect. If the thickness w1 of the stopper body portion 35 is reduced by at least 1 mm from the thickness of a typical vial stopper, the total oxygen permeation amount of the stopper 34 is equal to or higher than the oxygen permeation amount of a typical vial stopper. Thus, the total oxygen permeation amount of the stopper 34 can be equal to or higher than the oxygen permeation amount of a typical vial stopper without greatly reducing the thickness w1 of the stopper body portion 35 by more than 1 mm.

Furthermore, when the upper limit of the thickness of the barrier layer 81 composed of a fluoropolymer layer is set as described above, in particular, when the barrier layer 81 has a thickness of 50 μm or less, the following effect is produced. From the perspective of suppressing liquid leakage by the stopper 34, the stopper body portion 35 preferably has a thickness w1 of 0.5 mm or more. The barrier layer 81 with a thickness of 50 μm or less can sufficiently increase the total oxygen permeation amount of the stopper 34 including the stopper body portion 35 with a thickness w1 of 0.5 mm and the barrier layer 81. This can produce the sufficient effect of the stopper 34 suppressing liquid leakage and sufficiently increase the total oxygen permeation amount of the stopper 34.

Preferred thicknesses of the stopper body portion 35 and the barrier layer 81 are described from another perspective different from the perspective described above. The total oxygen permeability coefficient of the stopper 34 including the stopper body portion 35 and the barrier layer 81 is considered. The total oxygen permeability coefficient of the stopper 34 refers to an apparent total oxygen permeability coefficient of the stopper 34 when oxygen permeates in the thickness direction of the stopper 34 through the portion of the stopper body portion 35 with the thickness w1 and the barrier layer 81 overlapping the portion.

The relationship between the total oxygen permeability coefficient αₐₗₗ (cm³·20 μm/(m²·day·atm)) of the stopper 34, the thickness w1 (μm) of the stopper body portion 35, the thickness w2 (μm) of the barrier layer 81, the oxygen permeability coefficient α1 (cm³·20 μm/(m²·day·atm)) of the stopper body portion 35, and the oxygen permeability coefficient α2 (cm³·20 μm/(m²·day·atm)) of the barrier layer 81 is represented by the following formula (4).

$$[ Math . 5 ]$$

$$( w 1 + w 2 ) / {α}_{all} = w 1 / α1 + w 2 / α2 \qquad formula ( 4 )$$

The formula (4) is rearranged into the following formula (5).

$$[ Math . 6 ]$$

$${α}_{all} = ( w 1 + w 2 ) / ( w 1 / α1 + w 2 / α2 ) \qquad formula ( 5 )$$

The oxygen permeability of the stopper 34 can be expressed by αₐₗₗ·20/(w1+w2) (cm³/(m²·day·atm)) using the total oxygen permeability coefficient dal of the stopper 34. Furthermore, as described above, the stopper 34 preferably has an oxygen permeation amount of 0.1 (cm³/(day·atm)) or more. When the opening portion 33 has an opening area A (m²) and the stopper 34 has an oxygen permeability of 0.1/A (cm³/(m²·day·atm)), the stopper 34 can have an oxygen permeation amount of 0.1 (cm³/(day·atm)) or more.

Thus, the total oxygen permeability coefficient αₐₗₗ (cm³·20 μm/(m²·day·atm)) of the stopper 34, the thickness w1 (μm) of the stopper body portion 35, the thickness w2 (μm) of the barrier layer 81, and the opening area A (m²) of the opening portion 33 preferably satisfy the following formula (1). When the following formula (1) is satisfied, the stopper 34 can have an oxygen permeation amount of 0.1 (cm³/(day·atm)) or more.

$$[ Math . 7 ]$$

$${α}_{all} \times 20 / ( w 1 + w 2 ) \geq 0.1 / A \qquad formula ( 1 )$$

In consideration of the formula (5), if the following formula (6) is satisfied, the formula (1) is satisfied.

$$[ Math . 8 ]$$

$$20 / ( w 1 / α1 + w 2 / α2 ) \geq 0.1 / A \qquad formula ( 6 )$$

The stopper 34 more preferably has an oxygen permeation amount of 1 (cm³/(day·atm)) or more. When the following formula (7) is satisfied, the stopper 34 can have an oxygen permeation amount of 1 (cm³/(day·atm)) or more.

$$[ Math . 9 ]$$

$$20 / ( w 1 / α1 + w 2 / α2 ) \geq 1 / A \qquad formula ( 7 )$$

When the barrier layer 81 is composed of a p-xylylene layer, the barrier layer 81 preferably has a thickness w2 of 1000 nm or less for the following reason. When a typical vial stopper, which has a thickness of 4 mm or less, is used as the stopper body portion 35 as described above, the stopper body portion 35 has a thickness w1 of 4 mm or less. When the stopper body portion 35 is composed of a silicone rubber, the stopper body portion 35 has an oxygen permeability coefficient α1 of, for example, approximately 1.0×10⁶ (cm³·20 μm/(m²·day·atm)). The barrier layer 81 composed of a p-xylylene layer typically has an oxygen permeability coefficient α2 of 7.5×10² (cm³·20 μm/(m²·day·atm)) or more. Furthermore, when the container body 32 is a main body of a typical vial, the opening portion 33 of the container body 32 typically has an opening area A of approximately 0.0003 m² or more. Since the barrier layer 81 has a thickness w2 of 1000 nm or less, the formula (7) is satisfied at least when the stopper body portion 35 has a thickness w1 of 4 mm or less, the stopper body portion 35 has an oxygen permeability coefficient α1 of 1.0×10⁶ (cm³·20 μm/(m²·day·atm)) or more, the barrier layer 81 has an oxygen permeability coefficient α2 of 7.5×10² (cm³·20 μm/(m²·day·atm)) or more, and the opening portion 33 has an opening area A of approximately 0.0003 m² or more. Thus, when the stopper body portion 35 is composed of a silicone rubber, the barrier layer 81 is composed of a p-xylylene layer, and the container body 32 is a main body of a typical vial, the stopper 34 can have an oxygen permeation amount of 1 (cm³/(day·atm)) or more.

When the barrier layer 81 is composed of a fluoropolymer layer, the barrier layer 81 preferably has a thickness w2 of 100 μm or less for the following reason. Since the barrier layer 81 has a thickness w2 of 100 μm or less, the formula (7) is satisfied at least when the stopper body portion 35 has a thickness w1 of 4 mm or less, the stopper body portion 35 has an oxygen permeability coefficient α1 of 1.0×10⁶ (cm³·20 μm/(m²·day·atm)) or more, the barrier layer 81 has an oxygen permeability coefficient α2 of 1.0×10⁴ (cm³·20 μm/(m²·day·atm)) or more, and the opening portion 33 has an opening area A of approximately 0.0003 m² or more. Thus, when the stopper body portion 35 is composed of a silicone rubber, the barrier layer 81 is composed of a fluoropolymer layer, and the container body 32 is a main body of a typical vial, the stopper 34 can have an oxygen permeation amount of 1 (cm³/(day·atm)) or more.

As illustrated in FIGS. 3 and 4, the barrier layer 81 may have the second portion 81b. In such a case, when the stopper 34 closes the opening portion 33, the barrier layer 81 constitutes the surface of the stopper 34 in contact with the end portion of the opening portion 33 of the container body 32. In this case, when the upper limit of the thickness of the barrier layer 81 composed of a fluoropolymer layer is set as described above, the stopper 34 is brought into close contact with the end portion of the opening portion 33 with a smaller gap. This can more securely seal the container 30 with the liquid L and more effectively prevent leakage of the liquid L from the container 30.

The stopper 34 has a thickness of, for example, 0.5 mm or more and 3 mm or less. In other words, the sum of the thickness w1 of the stopper body portion 35 and the thickness w2 of the barrier layer 81 is, for example, 0.5 mm or more and 3 mm or less. The thickness of the stopper 34 refers to the thickness in the direction in which the stopper 34 is inserted into the opening portion 33. When the thickness of the stopper 34 is not constant, the thickness of the stopper 34 refers to the minimum thickness of the portion of the stopper 34 overlapping the opening portion 33. In FIGS. 3, 4, 5A, and 5B, the stopper 34 has the plate-like portion 34a. The portion of the stopper 34 overlapping the opening portion 33 has the minimum thickness in the portion constituting the plate-like portion 34a. In this case, the thickness of the stopper 34 corresponds to the thickness of the portion of the stopper 34 that constitutes the plate-like portion 34a and is located radially inside the tubular portion 34b.

The thickness w1 of the stopper body portion 35, the thickness w2 of the barrier layer 81, and the thickness of the stopper 34 are thicknesses in a state where the stopper 34 is not compressed. The thickness w1 of the stopper body portion 35 and the thickness w2 of the barrier layer 81 are values measured from an observed image of a cross section of the stopper 34. When the thickness w1 of the stopper body portion 35 is measured, the observed image of the cross section of the stopper 34 can be acquired with an optical microscope. When the thickness w2 of the barrier layer 81 is measured, the observed image of the cross section of the stopper 34 can be acquired with a scanning electron microscope (SEM). The thickness of the stopper 34 is determined by summing the thickness w1 of the stopper body portion 35 and the thickness w2 of the barrier layer 81.

As illustrated in FIG. 2A, the illustrated container body 32 has a bottom 32a, a trunk 32b, a neck 32c, and a head 32d in this order. The head 32d forms the opening portion 33 of the container body 32. The head 32d is thicker than other portions. The neck 32c is located between the trunk 32b and the head 32d. The neck 32c has a smaller width, particularly a smaller diameter, with respect to the trunk 32b and the head 32d. An inner surface of the container body 32 defines a storage space for the liquid L together with part of the surface of the stopper 34. The container body 32 may be transparent so that the contained liquid L can be observed from the outside. The term “transparent”, as used herein, refers to a visible light transmittance of 50% or more, preferably 80% or more. The visible light transmittance is determined as the average value of total light transmittance at each wavelength measured every 1 nm at an incident angle of 0 degrees in the measurement wavelength range of 380 nm to 780 nm using a spectrophotometer (“UV-3100PC” manufactured by Shimadzu Corporation, a product according to JIS K 0115).

The illustrated container 30 further includes the fixture 36. The fixture 36 restricts the detachment of the stopper 34 from the container body 32. The fixture 36 is attached to the head 32d of the container body 32. As illustrated in FIGS. 1 and 2A, the fixture 36 covers the periphery of the plate-like portion 34a of the stopper 34. The fixture 36 presses the flange portion of the plate-like portion 34a toward the head 32d. Thus, as illustrated in FIGS. 3 to 5B, the portion of the first surface 34e of the plate-like portion 34a located radially outside the tubular portion 34b is in contact with the end portion of the opening portion 33 formed by the head 32d. Thus, the fixture 36 restricts the detachment of the stopper 34 from the container body 32 while allowing a portion of the stopper 34 to be exposed. Furthermore, the space between the stopper 34 and the container body 32 can be made liquid-tight and air-tight. The fixture 36 makes the container 30 air-tight. A material of the fixture 36 is, for example, a metal, such as aluminum. The fixture 36 may be a sheet-like metal fixed to the head 32d. The fixture 36 may be a cap screwed to the head 32d.

In the illustrated example, the container body 32 is composed of a material with a lower oxygen permeability coefficient than a material of the stopper 34. The container body 32 may have an oxygen barrier property. In this case, the container 30 has oxygen permeability only in the stopper 34. A material constituting a portion with an oxygen barrier property may have an oxygen permeability coefficient of 5.0×10³ (cm³·20 μm/(m²·day·atm)) or less or 5.0×10⁻¹ (cm³·20 μm/(m²·day·atm)) or less.

The container body 32 with an oxygen barrier property is, for example, a can made of a metal, a container body having a metal layer formed by vapor deposition or transfer, or a glass bottle. An oxygen barrier property can also be imparted to the container body 32 produced using a resin sheet or a resin plate. In this example, the resin sheet or the resin plate may include, for example, a layer with an oxygen barrier property, such as ethylene-vinyl alcohol copolymer (EVOH) or poly(vinyl alcohol) (PVA). Furthermore, the container body 32 may have a laminate including a metallized film. The container body 32 including a laminate and the container body 32 including glass or a resin can be provided with transparency as well as an oxygen barrier property. A transparent container 30 or a transparent container body 32 is preferred in that the liquid L inside thereof can be observed from the outside of the container 30.

The container 30 may have a volume of, for example, 1 cm³ or more and 1100 cm³ or less, 3 cm³ or more and 700 cm³ or less, or 5 cm³ or more and 200 cm³ or less.

In the illustrated example, the container body 32 is a colorless or colored glass bottle. The container body 32 is formed of, for example, borosilicate glass. The container 30 may be a vial. The vial is a container including a container body, a stopper inserted into the opening portion of the container body, and a seal as the fixture 36 for fixing the stopper. In the container 30 as a vial, the seal is crimped to the head 32d of the container body 32 together with the stopper 34 using a hand clipper or the like. The seal is, for example, an aluminum seal. In such a case, the fixture 36 is made of aluminum. The container 30 as a vial may have a volume of 1 cm³ or more or 3 cm³ or more. The container 30 as a vial may have a volume of 500 cm³ or less or 200 cm³ or less.

When the container 30 is a vial, a material constituting the stopper 34 may have a higher oxygen permeability coefficient than the glass constituting the container body 32. From the perspective of promoting oxygen transfer from the inside of the container 30 to the outside of the container 30, the portion with oxygen permeability of the container 30 is preferably not in contact with the liquid L. The container 30 as a vial can be stably placed on a placement surface by bringing the bottom 32a of the container body 32 into contact with the placement surface. At this time, the stopper 34 is separated from the liquid L. The stopper 34 is not in contact with the liquid L. Thus, in a typical storage state of the container 30, oxygen permeation through the stopper 34 of the container 30 can be promoted.

In the liquid-containing container 30L, the stopper 34 comes into contact with the end portion of the opening portion 33 of the container body 32 and closes the opening portion 33 so as to seal the liquid L. In the example illustrated in FIGS. 1 and 2A, the stopper 34 is pressed against the end portion of the opening portion 33 by the fixture 36 and comes into contact with the end portion of the opening portion 33, thereby closing the opening portion 33 so as to seal the container 30 with the liquid L. The stopper 34 closes the opening portion 33 so as to seal the liquid L and thereby suppresses leakage of the liquid L from the container 30.

The phrase “the stopper 34 seals the liquid L” means that no leakage of the liquid L is observed in a liquid leakage test performed on the liquid-containing container 30L in which the stopper 34 comes into contact with the end portion of the opening portion 33 of the container body 32 and closes the opening portion 33, as illustrated in FIGS. 1 and 2A.

The liquid leakage test is performed by a tracer liquid test method specified in The Japanese Pharmacopoeia 18th edition. In particular, among tracer liquid test methods specified in The Japanese Pharmacopoeia 18th edition, a test method using an inflow of a tracer liquid is performed. In the tracer liquid test method, first, the liquid-containing container 30L containing 4 cm³ of pure water as the liquid L and having the opening portion 33 closed by the stopper 34 is prepared. A beaker containing a stain liquid is also prepared. The liquid-containing container 30L is then placed in the beaker and is submerged below the surface of the stain liquid in the beaker. The beaker is then placed in a depressurizable environment. For example, the beaker is placed in a desiccator with a function of reducing the pressure in the desiccator. The pressure of the atmosphere around the beaker is reduced by 30 kPa from atmospheric pressure for 10 minutes. At this time, the gas in the container 30 is discharged to the outside of the container 30 through the stopper 34 with oxygen permeability. When there is a gap between the stopper 34 and the opening portion 33, the gas in the container 30 is discharged to the outside of the container 30 through the gap. This reduces the pressure in the liquid-containing container 30L. The atmosphere around the beaker is then returned to atmospheric pressure and is allowed to stand for 30 minutes. At this time, if there is a gap between the stopper 34 and the opening portion 33, the stain liquid enters the depressurized container 30 from the outside of the container 30 held at atmospheric pressure through the gap. If there is no gap between the stopper 34 and the opening portion 33, the stain liquid does not enter the container 30 from the outside of the container 30. When the liquid L in the container 30 is dyed with the stain liquid after the beaker is left at atmospheric pressure for 30 minutes, it is determined that the stopper 34 does not seal the liquid L. When the liquid L in the container 30 is not dyed with the stain liquid, it is determined that the stopper 34 seals the liquid L.

In particular, the liquid leakage test is performed on the liquid-containing container 30L in a state where the stopper 34 is pressed against the end portion of the opening portion 33 by the fixture 36 made of aluminum illustrated in FIGS. 1 and 2A. In particular, the liquid leakage test is performed on the liquid-containing container 30L in a state where the stopper 34 is pressed against the end portion of the opening portion 33 by an aluminum seal fixed to the head 32d of the container body 32 by a hand clipper.

The illustrated container 30 at atmospheric pressure can maintain the internal pressure at a negative pressure. Thus, the container 30 at atmospheric pressure can contain a gas maintained at a negative pressure. The container 30 at atmospheric pressure may also contain a gas maintained at a positive pressure. In these examples, the container 30 may have sufficient rigidity to maintain its shape. The container 30 at atmospheric pressure may be somewhat deformed when the internal pressure is maintained at a negative pressure or a positive pressure. The container 30 that can maintain the internal pressure at a negative pressure or a positive pressure is, for example, the illustrated specific example or a can made of a metal.

The phrase “the container at atmospheric pressure can contain a gas maintained at a negative pressure” means that the gas can be stored without breakage while maintaining the internal pressure at a negative pressure of 0.80 atm or more. The container 30 at atmospheric pressure that can contain a gas maintained at a negative pressure may be an air-tight container even at an internal pressure of 0.80 atm. In a container at atmospheric pressure that can contain a gas maintained at a negative pressure, the volume at an internal pressure of 0.80 atm can be maintained at 95% or more of the volume at an internal pressure of 1.0 atm.

Next, the barrier container 40 is described. The barrier container 40 has a volume for storing the container 30. The barrier container 40 can be closed, for example, by welding, such as heat seal or ultrasonic bonding, or joining using a joint material, such as a tackifier or an adhesive. The barrier container 40 may be an air-tight container. The barrier container 40 may have a volume of, for example, 5 cm³ or more and 1200 cm³ or less. When the container 30 is a small container, such as a vial, for example, a container with a volume of 1 cm³ or more and 20 cm³ or less, the barrier container may have a volume of 1.5 cm³ or more and 500 cm³ or less.

The barrier container 40 has an oxygen barrier property. The phrase “container with an oxygen barrier property” means that the container has an oxygen permeability (cm³/(m²·day·atm)) of 1 or less. The container with an oxygen barrier property may have an oxygen permeability (cm³/(m²·day·atm)) of 0.5 or less or 0.1 or less. The oxygen permeability is measured in accordance with JIS K 7126-1. The oxygen permeability is measured in an environment with a temperature of 23° C. and a humidity of 40% RH using a permeability measuring instrument OXTRAN (2/61) manufactured by MOCON, Inc., U.S.A. For a container to which JIS K 7126-1 is not applied, the oxygen permeation amount may be measured and divided by the surface area to specify the oxygen permeability.

A material constituting the barrier container 40 with an oxygen barrier property may have an oxygen permeability coefficient of 5.0×10³ (cm³·20 μm/(m²·day·atm)) or less or 5.0×10⁻¹ (cm³·20 μm/(m²·day·atm)) or less.

The barrier container 40 with an oxygen barrier property is, for example, a can made of a metal, a container having a metal layer formed by vapor deposition or transfer, or a glass bottle. The barrier container 40 may include a laminate including a layer with an oxygen barrier property. The laminate may include a resin layer with an oxygen barrier property, such as an ethylene-vinyl alcohol copolymer (EVOH) or poly(vinyl alcohol) (PVA), or a metallized film. The barrier container 40 may include a transparent portion. A portion of the barrier container 40 may be transparent. The entire barrier container 40 may be transparent. The barrier container 40 including a laminate and the barrier container 40 including glass or a resin can be provided with transparency as well as an oxygen barrier property. To impart transparency to the barrier container 40 is preferred from the perspective that the liquid-containing container 30L placed therein can be observed from the outside of the barrier container 40.

In the illustrated example, the barrier container 40 is produced using a resin film with an oxygen barrier property. The barrier container 40 is formed as a so-called pouch. The barrier container 40 is formed as a so-called gusset bag. More specifically, the barrier container 40 has a first main film 41a, a second main film 41b, a first gusset film 41c, and a second gusset film 41d. The first main film 41a and the second main film 41b are disposed to face each other. The first gusset film 41c is creased and disposed between the first main film 41a and the second main film 41b. The first gusset film 41c connects one side edge of the first main film 41a to one side edge of the second main film 41b. The second gusset film 41d is creased and disposed between the first main film 41a and the second main film 41b. The second gusset film 41d connects the other side edge of the first main film 41a to the other side edge of the second main film 41b. The first and second main films 41a and 41b and the first and second gusset films 41c and 41d are joined together also at their upper edges and lower edges. The films 41a to 41d are hermetically joined, for example, by welding, such as heat seal or ultrasonic bonding, or joining using a joint material, such as a tackifier or an adhesive.

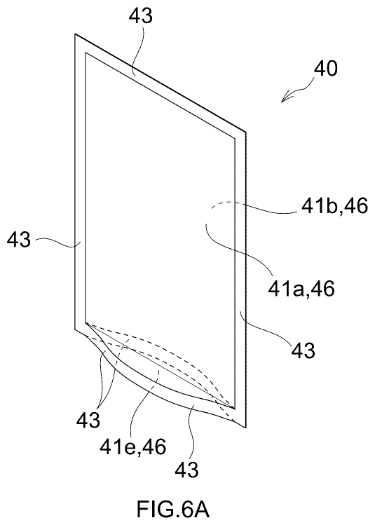

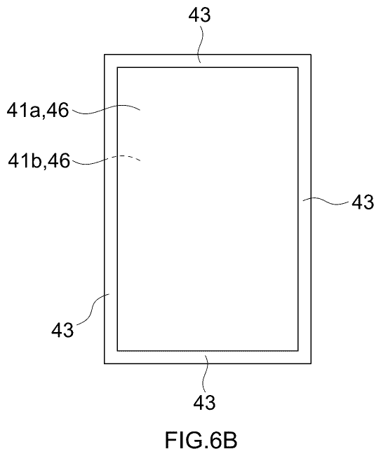

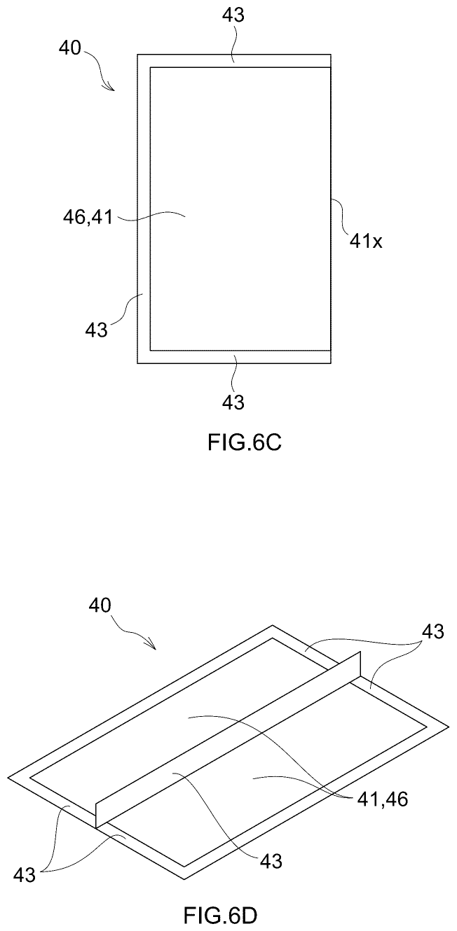

Adjacent two or more of the films 41a to 41d may be formed by folding one film instead of joining separate films. As illustrated in FIG. 1, the gusset bag can form a rectangular bottom in the barrier container 40. The container 30 can be placed on the bottom and stably stored in the barrier container 40. As illustrated in FIG. 6A, the barrier container 40 may also be a pouch including a bottom film 41e together with the first main film 41a and the second main film 41b, instead of the gusset bag. This pouch is also referred to as a standing pouch. This pouch can also form the bottom and can stably store the container 30 in the barrier container 40.

Furthermore, as illustrated in FIGS. 6B to 6D, the barrier container 40 that can be developed into a flat shape may be used. Each barrier container 40 illustrated in FIGS. 6B to 6D can be produced by joining resin films at a seal portion. The barrier container 40 illustrated in FIG. 6B can be produced by joining the first main film 41a and the second main film 41b at a seal portion 43 provided along the periphery thereof.

The barrier container 40 illustrated in FIG. 6C has a film 41 folded at a folding portion 41x. The facing portions of the folded film 41 can be joined at the seal portion 43 to produce the barrier container 40. In the barrier container 40 illustrated in FIG. 6C, a storage space is formed in a portion surrounded by the folding portion 41x and the three-sided seal portion 43.

The barrier container 40 illustrated in FIG. 6D is also referred to as a pillow type. The barrier container 40 is produced by joining both ends of one film 41 as the seal portion 43 to form the film 41 into a tubular shape and further joining both tubular end portions as the seal portion 43.

In the various examples described above, the films forming the barrier container 40 may be transparent.

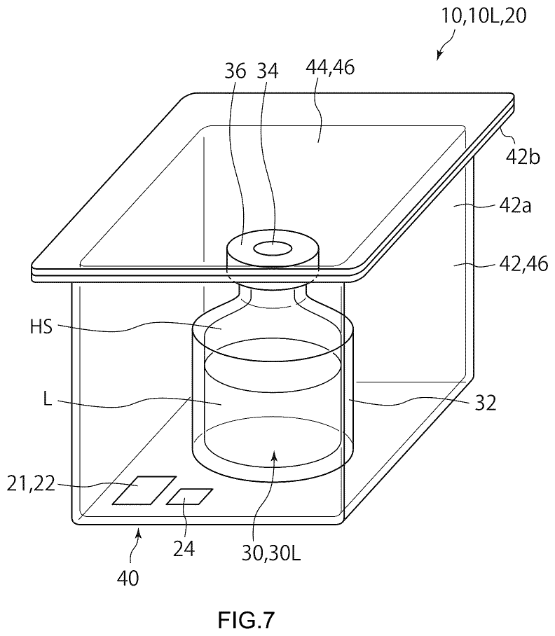

In another example, as illustrated in FIG. 7, the barrier container 40 may have a container body 42 and a lid 44. The container body 42 has a storage portion 42a and a flange portion 42b. The storage portion 42a forms a rectangular parallelepiped storage space. The container 30 is stored in the storage space. The storage portion 42a has a rectangular parallelepiped external shape with one opened surface. The flange portion 42b is provided on the periphery of the opening of the storage portion 42a. The lid 44 is flat. The periphery of the lid 44 can be hermetically joined to the flange portion 42b of the container body 42. The container body 42 and the lid 44 may be formed of a resin plate with an oxygen barrier property. The lid 44 and the container body 42 may be transparent. The resin plate with an oxygen barrier property may have a thicknesses of 0.05 mm or more and 2 mm or less, or 0.1 mm or more and 1.5 mm or less.

The barrier container 40 at atmospheric pressure can maintain the internal pressure at a negative pressure. Thus, the barrier container 40 at atmospheric pressure can contain a gas maintained at a negative pressure. The phrase “the container at atmospheric pressure can contain a gas maintained at a negative pressure” means that the gas can be stored without breakage while maintaining the internal pressure at a negative pressure of 0.80 atm or more. The barrier container 40 at atmospheric pressure that can contain a gas maintained at a negative pressure may be in an air-tight state at an internal pressure of 0.80 atm. In a container at atmospheric pressure that can contain a gas maintained at a negative pressure, the volume at an internal pressure of 0.80 atm may be maintained at 95% or more of the volume at an internal pressure of 1.0 atm. The barrier container 40 at atmospheric pressure may contain a gas maintained at a positive pressure. The phrase “the container at atmospheric pressure can contain a gas maintained at a positive pressure” means that the gas can be stored without breakage while maintaining the internal pressure at a positive pressure of 1.2 atm or more. The barrier container 40 at atmospheric pressure that can contain a gas maintained at a positive pressure may be in an air-tight state at an internal pressure of 1.20 atm. In a container at atmospheric pressure that can contain a gas maintained at a positive pressure, the volume at an internal pressure of 1.2 atm may be maintained at 105% or less of the volume at an internal pressure of 1.0 atm. The barrier container 40 has sufficient rigidity to maintain its shape. The barrier container 40 at atmospheric pressure may be somewhat deformed when the internal pressure is maintained at a negative pressure or a positive pressure.

From the perspective of promoting oxygen transfer from the inside of the container 30 to the inside of the barrier container 40, the stopper 34 with oxygen permeability is preferably at least partially separated from the barrier container 40 with an oxygen barrier property. In the illustrated example, a gap G is formed between the stopper 34 of the container 30 in the barrier container 40 and the barrier container 40. From the perspective of ensuring the gap G, the storage space of the barrier container 40 is preferably larger than the external shape of the container 30. When the barrier container 40 is formed of a flexible material, such as a resin film, the shape of the barrier container 40 can be adjusted to form the gap G between the stopper 34 and the barrier container 40.

The liquid-containing container 30L and the barrier container 40 described above constitute the container set 20. The container set 20 including the liquid-containing container 30L and the barrier container 40 is used to produce the liquid-containing combined container 10L. The container 30 and the container set 20 are used to produce a combined container 10.

Next, a method for producing the liquid-containing combined container 10L is described. The liquid-containing combined container 10L is produced to obtain the liquid-containing container 30L with an adjusted oxygen concentration. The method for producing the liquid-containing combined container 10L includes a step of closing the barrier container 40 storing the container 30 and a step of adjusting the amount of oxygen in the container 30.

First, the liquid-containing container 30L and the barrier container 40 before closing are prepared. The liquid-containing container 30L is produced by filling the container 30 with the liquid L. For example, the liquid L, such as food or a chemical, is produced using a production line installed in an sterile environment maintained at a positive pressure. The sterile environment is maintained at a positive pressure from the perspective of suppressing entry of a foreign material, such as bacteria. Consequently, the liquid-containing container 30L has a positive internal pressure similar to the production environment.

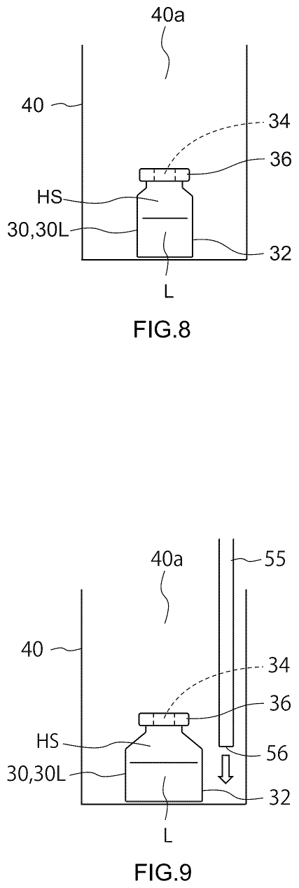

As illustrated in FIG. 8, an opening 40a for storing the liquid-containing container 30L remains in the barrier container 40 before being closed. In the barrier container 40 illustrated in FIG. 1, for example, the upper edge portions of the films 41a to 41d form the opening 40a without being joined together. In the barrier container 40 illustrated in FIG. 7, the container body 42 without the lid 44 is prepared. As illustrated in FIG. 8, the liquid-containing container 30L is stored in the barrier container 40 through the opening 40a.

The barrier container 40 is then filled with an inert gas, for example, nitrogen. In the example illustrated in FIG. 9, an inert gas is supplied through a feed pipe 55. The feed pipe 55 enters the barrier container 40 through the opening 40a. A discharge port 56 of the feed pipe 55 is positioned inside the barrier container 40. The inert gas is supplied through the feed pipe 55 for substitution with the inert gas in the barrier container 40. Thus, the liquid-containing container 30L is placed in an inert gas atmosphere. The inert gas is a stable gas with low reactivity. The inert gas other than nitrogen is, for example, a noble gas, such as helium, neon, or argon.

Filling the barrier container 40 with the inert gas and placing the liquid-containing container 30L in the barrier container 40 may be performed in any order or in parallel.

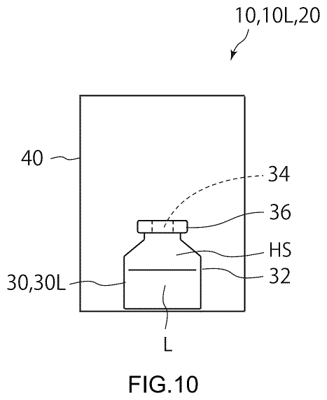

Next, as illustrated in FIG. 10, while the liquid-containing container 30L is stored and the inert gas is filled, the barrier container 40 is closed. In other words, the barrier container 40 storing the container 30 is closed. In the barrier container 40 illustrated in FIG. 1, the upper edge portions of the films 41a to 41d are joined together to close the opening 40a and close the barrier container 40. In the barrier container 40 illustrated in FIG. 7, the flange portion 42b of the container body 42 is joined to the periphery of the lid 44 to close the barrier container 40. The joining may be performed using a joint material, such as a tackifier or an adhesive, or may be welding by heat seal, ultrasonic bonding, or the like. The barrier container 40 is in an air-tight state when closed.

Instead of supplying the inert gas through the feed pipe 55, the barrier container 40 storing the liquid-containing container 30L in an inert gas atmosphere may be closed. The liquid-containing container 30L is also enclosed by this method in the barrier container 40 together with the inert gas.

The process until the barrier container 40 is closed may be performed in an sterile environment. More specifically, the liquid-containing container 30L produced under sterile conditions and the barrier container 40 sterilized or produced under sterile conditions are placed, for example, in a sterile environment, such as a clean room. If this room is separated from the air atmosphere and is in an inert gas atmosphere, the supply of the inert gas through the feed pipe 55 can be omitted. The barrier container 40 storing the liquid-containing container 30L is then closed in the sterile environment. Thus, the inside of the barrier container 40 storing the liquid-containing container 30L is also under sterile conditions. Thus, the liquid-containing container 30L can be stored in the barrier container 40 under sterile conditions.

The amount of oxygen in the container 30 is then adjusted. In the step of adjusting the amount of oxygen in the container 30, the oxygen in the container 30 permeates through the stopper 34, and the concentration of oxygen in the container 30 decreases. An example of a method of adjusting the amount of oxygen in the container 30 is described below. In the step of adjusting the amount of oxygen in the container 30, the liquid-containing container 30L is stored in the barrier container 40. As described above, the barrier container 40 has an oxygen barrier property. This effectively suppresses oxygen permeation through the barrier container 40. On the other hand, the container 30 has oxygen permeability at the stopper 34. The barrier container 40 is filled with an inert gas, and the concentration of oxygen in the barrier container 40 is very low. In the liquid-containing combined container 10L, oxygen in the container 30 permeates through the stopper 34 and is transferred into the barrier container 40. Oxygen transfer from the container 30 to the barrier container 40 increases the concentration of oxygen in the barrier container 40 and decreases the concentration of oxygen in the container 30. In a final equilibrium state where oxygen permeation through the container 30 is in equilibrium, the concentration of oxygen in the container 30 may be the same as the concentration of oxygen in the barrier container 40.

Furthermore, a decrease in the concentration of oxygen in the container 30 causes a decrease in the oxygen partial pressure in the container 30. A decrease in the oxygen partial pressure in the container 30 also causes a decrease in the saturation solubility (mg/L) of oxygen in the liquid L in the container 30. This reduces the amount of oxygen dissolved in the liquid L (mg/L).

As described above, storing the liquid-containing container 30L in the barrier container 40 can adjust the amount of oxygen in the container 30. In particular, storing the liquid-containing container 30L in the barrier container 40 can reduce the concentration of oxygen (%) in the gas contained together with the liquid in the container 30. This can also reduce the amount of oxygen (mg/L) dissolved in the liquid L in the container 30. For example, storing the liquid-containing container 30L in the barrier container 40 before use can reduce the amount of oxygen (mg/L) dissolved in the liquid L in the container 30. On the other hand, a highly sensitive liquid L, for example, food or a chemical, may be decomposed by oxygen. For example, a solute in an aqueous solution as a chemical may be decomposed by oxygen. A solute in a liquid as a chemical or an aqueous solution as a chemical may be decomposed by oxygen. Particles dispersed in a suspension as a chemical or food may be decomposed by oxygen. On the other hand, storing the liquid L in the container 30 placed inside the barrier container 40 can suppress the decomposition of the liquid L by oxygen. Thus, the present embodiment in which the concentration of oxygen in the container 30 can be adjusted after the liquid Lis sealed is suitable for a highly sensitive liquid L, for example, food or a chemical.

Instead of filling the barrier container 40 with the inert gas or in addition to filling the barrier container 40 with the inert gas when the barrier container 40 is closed, a deoxidizer 21 that absorbs oxygen in the barrier container 40 may be provided. The deoxidizer 21 absorbing oxygen reduces the concentration of oxygen in the barrier container 40 and transfers oxygen in the container 30 to the barrier container 40. The deoxidizer 21 can be used to more effectively reduce the concentration of oxygen in the barrier container 40 and the concentration of oxygen in the container 30. The present inventors have confirmed that the use of a sufficient amount of the deoxidizer 21 can reduce the concentration of oxygen in the barrier container 40 and the concentration of oxygen in the container 30, for example, to less than 0.3%, 0.1% or less, 0.05% or less, less than 0.03%, or even 0%. Furthermore, as the concentration of oxygen in the container 30 decreases, the amount of oxygen dissolved in the liquid L in the container 30 also decreases. The present inventors have confirmed that the use of a sufficient amount of the deoxidizer 21 can significantly reduce the amount of oxygen dissolved in the liquid L, for example, to less than 0.15 mg/L, less than 0.04 mg/L, 0.03 mg/L or less, 0.02 mg/L or less, less than 0.015 mg/L, more preferably 0 mg/L.

The amount of the deoxidizer 21 is set to an amount at which the total amount of oxygen present in the container 30 and the barrier container 40 can be absorbed.

An apparatus for measuring the concentration of oxygen (%) in the container 30 and the concentration of oxygen (%) in the barrier container 40 may be, but is not limited to, an oxygen content meter using a headspace method, a fluorescence contact type oxygen content meter, or a fluorescence non-contact type oxygen content meter. An apparatus for measuring the amount of oxygen (mg/L) dissolved in the liquid in the container 30 may be, but is not limited to, a fluorescence contact type oxygen content meter or a fluorescence non-contact type oxygen content meter An apparatus for measuring the concentration of oxygen or the amount of dissolved oxygen can be appropriately selected in consideration of the measurement limit, the measurement stability in the concentration range of oxygen to be measured, the measurement environment, the measurement conditions, and the like. To measure a low concentration of oxygen or a low amount of dissolved oxygen, a fluorescence contact type oxygen content meter may be used, or a fluorescence non-contact type oxygen content meter may be used.

The oxygen content meter using the headspace method is, for example, a headspace analyzer FMS760 manufactured by lighthouse. In the measurement using this measuring apparatus, a container containing oxygen to be measured is irradiated from the outside of the container with light having a frequency that can be absorbed by oxygen, and the light that passes through the headspace HS of the container and exits from the container is received. A change in light intensity due to the permeation can be measured to determine the concentration of oxygen (%) in the container on the basis of the change in light intensity. Thus, if the container 30 can transmit light from the measuring apparatus, the concentration of oxygen in the container 30 can be determined without opening the container 30. If the barrier container 40 can transmit light from the measuring apparatus, the concentration of oxygen in the container 30 stored in the barrier container 40 can also be measured by light irradiation from the outside of the barrier container 40 without opening the barrier container 40. The concentration of oxygen (%) in the barrier container 40 can also be measured with the headspace analyzer FMS760 manufactured by lighthouse. The saturation solubility of oxygen in the liquid L can be determined from the measured oxygen concentration (%) and temperature of the headspace HS. The amount of oxygen (mg/L) dissolved in the liquid L can be determined on the basis of the saturation solubility.

The fluorescence contact type oxygen content meter is, for example, an oxygen content meter Microx4 manufactured by PreSens, Germany. The oxygen content meter Microx4 is a needle-type apparatus. The oxygen content meter Microx4 can measure the concentration of oxygen and the amount of dissolved oxygen in a container by puncturing the container with a needle and has high measurement stability. Temporal changes in the amount of oxygen can be evaluated by preparing a plurality of containers or combined containers produced under the same conditions and measuring the amount of oxygen in each container at different timings using a needle-type oxygen content meter.

An oxygen sensor placed in the container in advance can measure the concentration of oxygen and the amount of dissolved oxygen in the container 30 and the barrier container 40 using a fluorescence non-contact type oxygen content meter. The fluorescence non-contact type oxygen content meter is, for example, an oxygen content meter Fibox3 manufactured by PreSens, Germany. An oxygen sensor emits light by itself upon receiving light in a specific wavelength region. The amount of light emitted by an oxygen sensor increases with the amount of oxygen around the sensor. A fluorescence non-contact type oxygen content meter can emit light of a specific wavelength that can be self-emitted by an oxygen sensor, and can measure the self-emission amount of the oxygen sensor to measure the concentration of oxygen (%) and the amount of dissolved oxygen (mg/L). In the container 30 stored in the barrier container 40, the amount of oxygen dissolved in the liquid L can be measured by light irradiation from the outside of the barrier container 40 without opening the barrier container 40.

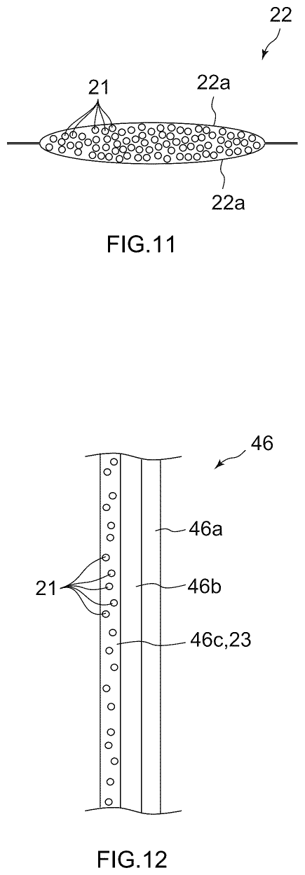

The deoxidizer 21 may be any composition that can absorb oxygen. The deoxidizer 21 may be an iron deoxidizer or a nonferrous deoxidizer. For example, the deoxidizer may be a deoxidizer composition containing, as a main component for an oxygen-absorbing reaction, a metal powder, such as an iron powder, a reducing inorganic substance, such as an iron compound, a reducing organic substance, such as a polyhydric phenol, a polyhydric alcohol, ascorbic acid, or a salt thereof, a metal complex, or the like. In the examples illustrated in FIGS. 1 and 7, a combined container 10 includes a deoxidizing member 22 in the barrier container 40 together with the liquid-containing container 30L. As illustrated in FIG. 11, the deoxidizing member 22 includes a package 22a with oxygen permeability and the deoxidizer 21 in the package 22a. The deoxidizing member 22 containing the deoxidizer 21 may be an iron-based moisture-dependent FX type, an iron-based self-reacting S type, an SPE type, a ZP type, a ZI-PT type, a ZJ-PK type, an E type, an organic self-reacting GLS type, a GL-M type, a GE type, or the like available from Mitsubishi Gas Chemical Co., Inc. The deoxidizing member 22 containing the deoxidizer 21 may be a ZH type, a Z-PK type, a Z-PR type, a Z-PKR type, a ZM type, or the like for a pharmaceutical agent available from Mitsubishi Gas Chemical Co., Inc.

The deoxidizer 21 may be contained in a deoxidizing film 23. For example, FIG. 12 illustrates the films 41a to 41e of the barrier container 40 illustrated in FIGS. 1 and 6A to 6D and a laminate 46 constituting the container body 42 and the lid 44 of the barrier container 40 illustrated in FIG. 7. The laminate 46 illustrated in FIG. 12 includes a first layer 46a, a second layer 46b, and a third layer 46c. For example, the first layer 46a may be an outermost layer composed of poly (ethylene terephthalate), nylon, or the like. The second layer 46b may be an oxygen barrier layer formed of an aluminum foil, an inorganic vapor-deposited film, a metallized film, or the like. The third layer 46c may be the innermost layer constituting a heat seal layer. The third layer 46c illustrated in the drawing contains a base material composed of a thermoplastic resin and the deoxidizer 21 dispersed in the base material. Thus, in the example illustrated in FIG. 12, the barrier container 40 has the deoxidizing film 23 containing the deoxidizer 21 as a portion of the laminate 46. The deoxidizer 21 may be contained not only in a heat seal layer or the innermost layer but also in a sticky layer or an intermediate layer of the laminate. In another example, the container 30 may include the deoxidizing film 23 containing the deoxidizer 21. The deoxidizer 21 may be provided separately from the container 30 or the barrier container 40 as in the examples illustrated in FIGS. 1 and 7 or may be provided as a portion of the container 30 or the barrier container 40 as illustrated in FIG. 12.

Furthermore, a dehydrating agent 24 for absorbing moisture in the barrier container 40 may be provided. The dehydrating agent 24 is a substance with a property of absorbing moisture, such as water vapor or water, or a composition containing the substance. The dehydrating agent 24 is, for example, calcium chloride, soda lime, silica gel, or the like. Such a dehydrating agent 24 may be contained in the barrier container 40 together with the container 30, and the barrier container 40 may be closed. In the example illustrated in FIG. 1, the dehydrating agent 24 is disposed in the barrier container 40 as a dehydrating member in a package. Alternatively, like the deoxidizer described above, a dehydrating film containing a dehydrating material may be included as a portion of the container 30 or the barrier container 40. In this example, an oxygen barrier layer constituting the barrier container 40 and a dehydrating film containing the dehydrating agent 24 may be stacked and integrated. When a non-aqueous solvent, such as glycerin or an alcohol, is contained in the container 30, moisture, such as water vapor or water, in the container 30 can be removed by the dehydrating agent 24 in the barrier container. The present inventors have confirmed that a dehydrating agent in the barrier container 40 could reduce the water content of the container 30 to 100 μg or less, 50 μg or less, or 10 μg or less.

When the dehydrating agent 24 is used, the water content of the container 30 can be measured by the Karl Fischer method. More specifically, the water content of the container 30 can be determined by a coulometric titration method using a Karl Fischer moisture meter MKC-610 manufactured by Kyoto Electronics Manufacturing Co., Ltd.

Furthermore, an oxygen detection material 25 for detecting the oxygen state in the barrier container 40 may be provided. The oxygen detection material 25 may display the detected oxygen state. The oxygen detection material 25 may detect the oxygen concentration. The oxygen detection material 25 may display the detected oxygen concentration. The oxygen detection material 25 may display the detected oxygen concentration by color.

The oxygen detection material 25 may contain a variable organic dye with a color reversibly changed by oxidation-reduction. For example, an oxygen reducing agent may contain an organic dye, such as a thiazine dye, an azine dye, or an oxazine dye, and a reducing agent, and may be in a solid form. An oxygen reducing agent may contain an oxygen indicator ink composition. The oxygen indicator ink composition may contain a resin solution, a thiazine dye or the like, a reducing saccharide, and an alkaline substance. The thiazine dye or the like, the reducing saccharide, and the alkaline substance may be dissolved or dispersed in the resin solution. A substance in the oxygen detection material 25 may be reversibly changed by oxidation and reduction. When the oxygen detection material 25 containing a reversible substance is used, the oxygen detection material 25 in the container changes the display color with deoxygenation in the container before the deoxygenation is completed, so that the amount of oxygen in the container can be observed from the outside of a transparent container to understand the state related to the oxygen in the container. Furthermore, the oxygen detection material 25 in the container can inform, by changing the display color, an increase in oxygen concentration after the completion of deoxygenation, for example, a state in which a pinhole or the like is formed in the container during a distribution process or the like and oxygen flows into the container.

More specifically, a commercially available tablet type oxygen detection material is, for example, the oxygen detection material 25 available from Mitsubishi Gas Chemical Company, Inc. under the trade name of “Ageless Eye”. An oxygen detection material coated with an ink composition having an oxygen detection function is, for example, the oxygen detection material 25 available from Mitsubishi Gas Chemical Company, Inc. under the trade name of “Paper Eye”. “Ageless Eye” and “Paper Eye” are functional products that can easily indicate by a color change an anaerobic condition in which the concentration of oxygen in a transparent container is less than 0.1% by volume. As the oxygen detection material 25, a material that can be used for freshness preservation of food, quality preservation of a pharmaceutical agent, or the like may be used together with a deoxidizer, for example, a deoxidizer available from Mitsubishi Gas Chemical Company, Inc. under the trade name of “Ageless”.

As illustrated in FIG. 1, the oxygen detection material 25 may have a display portion 26 that can be observed from the outside of the transparent barrier container 40. In the example illustrated in FIG. 1, the oxygen detection material 25 is contained in the barrier container 40 in the same manner as the deoxidizer 21 or the deoxidizing member 22. The oxygen detection material 25 may be joined to the inner surface of the barrier container 40 or the outer surface of the container 30 by welding or via a joint material. The oxygen detection material 25 may be disposed such that the display portion 26 thereof is not made unobservable by the deoxidizing member 22 or the dehydrating agent 24. When a label is attached to the container 30, the deoxidizing member 22, the dehydrating agent 24, and the oxygen detection material 25 are preferably disposed so as not to cover the label.

Furthermore, the oxygen detection material 25 may detect the oxygen state in the container 30. The oxygen detection material 25 may be contained in the container 30. The oxygen detection material 25 may display the oxygen state detected in the container 30. The oxygen detection material 25 may detect the concentration of oxygen in the container 30. The oxygen detection material 25 may display the concentration of oxygen detected in the container 30. The oxygen detection material 25 may display the concentration of oxygen detected in the container 30 by color.

The concentration of oxygen in the space of the container 30 not occupied by the liquid L, that is, the headspace HS, can also be reduced to approximately 1.5% or less by inert gas replacement in the headspace HS, bubbling the liquid L with an inert gas, or the like before attaching the stopper 34 to the container body 32. For example, the concentration of oxygen in the headspace HS is reduced to 0.5% or more and 1% or less. Furthermore, it is thought that producing a liquid in an atmosphere replaced with an inert gas and storing the liquid in a container with an oxygen barrier property can reduce the amount of oxygen dissolved in the liquid in the container. However, installation of the entire liquid production line in an atmosphere replaced with an inert gas requires modification of large-scale production facilities and enormous capital investment. Furthermore, in the field of expensive chemicals and the like, to ensure stability against temperature, oxygen, moisture, light, and the like, the chemicals are lyophilized and stored in a powder form. However, it is disadvantageous in terms of labor, time, and cost to convert a liquid chemical into a powder for storage and to reconstitute a powder chemical into a liquid for use.

In contrast, according to the present embodiment, it is possible to produce a liquid-containing container as before using existing equipment or the like. Thus, equipment repair and capital investment can be avoided. In particular, for application to a liquid, such as a chemical, it is also useful in that it is possible to omit an application for approval to a public institution regarding changes in production facilities and production processes. Furthermore, it is possible to save time and effort, such as lyophilizing the liquid L or reconstituting a powder into a liquid. Furthermore, the container 30 is not particularly limited. Thus, it is possible to adopt a material, such as glass or resin, widely used as a material of a container for food, a chemical, or the like due to a small elution amount. In the present embodiment, the container body 32 has barrier properties. In this case, a material of the container body 32 is, for example, glass. A material of the container body 32 may be a resin with barrier properties, such as a cycloolefin polymer.

Furthermore, in the specific examples described above, the container 30 includes the container body 32 and the stopper 34. The container 30 may be a vial. A vial containing a liquid, in particular, a vial containing a liquid under sterile conditions, has been produced using butyl rubber or fluororubber with low oxygen permeability and an oxygen barrier property. In contrast, in the specific examples described above, the stopper 34 has oxygen permeability. In other words, oxygen can permeate the stopper 34. For example, the oxygen permeability coefficient (cm³·20 μm/(m²·day·atm)) of a material constituting the stopper 34 is set to be high. The stopper 34 may be composed of silicone or a silicone rubber. Furthermore, the oxygen permeability coefficient of silicone or a silicone rubber constituting the stopper 34 may be higher than the oxygen permeability coefficient of a material constituting the container body 32. In such a specific example, oxygen passes through the stopper 34 and out of the container 30. Thus, the use of the stopper 34 with oxygen permeability can easily impart oxygen permeability to an existing container, such as a conventionally used vial.

In this specific example, the time to equilibrium depends on the oxygen permeability of the stopper 34. Thus, adjusting the opening area of the opening portion 33 of the container body 32 and the thickness of the stopper 34 as described above can reduce the time from the storage of the container 30 in the barrier container 40 to the equilibrium of oxygen permeation through the container 30. This can suppress the decomposition of the liquid L by oxygen.

Furthermore, the partial volume (the volume of the headspace HS) of the container 30 obtained by subtracting the volume of the liquid L from the volume of the container 30 may be 50 cm³ or less, 30 cm³, 10 cm³, or 5 cm³ or less. The liquid-containing combined container 10L can reduce the time from the closure of the barrier container 40 storing the container 30 to the equilibrium of oxygen permeation through the container 30. This can suppress the decomposition of the liquid L by oxygen.

Similarly, the volume of the liquid L in the container 30 may be 20 cm³ or less or 10 cm³ or less. The liquid-containing combined container 10L can reduce the time from the closure of the barrier container 40 storing the container 30 to the equilibrium of oxygen permeation through the container 30. This can suppress the decomposition of the liquid L by oxygen.

Furthermore, an upper limit and a lower limit may be set for the ratio (%) of the partial volume (cm³) (the volume of the headspace HS) of the container 30 obtained by subtracting the volume of the liquid L from the volume of the container 30 to the partial volume (cm³) of the barrier container 40 obtained by subtracting the volume of the container 30 from the volume of the barrier container 40. This ratio may be 50% or less or 20% or less. Setting such an upper limit can reduce the concentration of oxygen in the container 30. Furthermore, a storage space for the container 30 can be secured in the barrier container 40 to easily store the container 30 in the barrier container 40. This can also reduce the time from the closure of the barrier container 40 storing the container 30 to the equilibrium of oxygen permeation through the container 30. This can suppress the decomposition of the liquid L by oxygen. The ratio may be 5% or more or 10% or more. Setting such a lower limit prevents the barrier container 40 from becoming excessively larger than the container 30 and can reduce the decrease in the handleability of the combined container 10.

Whether the oxygen permeation through the container 30 is in an equilibrium state is determined on the basis of the concentration of oxygen in the container 30. In this determination, it is determined that the equilibrium state is reached when the difference between the concentration of oxygen (%) in the container 30 at a certain time point and the concentration of oxygen (%) in the container 30 24 hours before the certain time point is ±5% or less of the concentration of oxygen (%) in the container 30 at the certain time point.

As described above, it is possible to produce the liquid-containing container 30L and the liquid-containing combined container 10L in which the concentration of oxygen and the amount of dissolved oxygen are adjusted. In an equilibrium state in which the oxygen permeation through the container 30 is in equilibrium, for example, the concentration of oxygen in the container 30 and the concentration of oxygen in the barrier container 40 may be less than 1%. The concentration of oxygen (%) in the headspace HS in the container 30 is often difficult to reduce only by inert gas replacement or bubbling in the related art due to the liquid L in the container 30. Consequently, it has been difficult to reduce a large amount of oxygen dissolved in the liquid L. In contrast, according to a specific example of the embodiment described above, since the liquid-containing container 30L and a gas are stored in the barrier container 40 and it is not necessary to store the liquid L as it is, it is possible to sufficiently reduce the concentration of oxygen in the barrier container 40. Thus, the concentration of oxygen in the container 30 in the equilibrium state can be less than 1% by adjusting the volume of the barrier container 40. Such an operation and effect are suitable when the liquid L is a highly sensitive chemical or food.

In particular, when the deoxidizer 21 that absorbs oxygen in the barrier container 40 is used, the concentration of oxygen in the container 30 can be reduced to less than 0.3%, 0.1% or less, 0.05% or less, less than 0.03%, or even 0%, and the concentration of oxygen in the barrier container 40 can be reduced to less than 0.3%, 0.1% or less, 0.05% or less, less than 0.03%, or even 0%. When the deoxidizer 21 that absorbs oxygen in the barrier container 40 is used, the amount of oxygen dissolved in the liquid L in the container 30 can be reduced to less than 0.15 mg/L, less than 0.04 mg/L, 0.03 mg/L or less, even less than 0.015 mg/L, or even 0 mg/L. Furthermore, the deoxidizer 21 disposed outside the container 30 does not impair the sterilization state inside the container 30.

If a long period is required until the concentration of oxygen or the amount of dissolved oxygen is reduced, the liquid L is degraded by oxygen. The period or time from the closure of the barrier container 40 to the equilibrium of oxygen permeation through the container 30 is preferably 4 weeks or less. If the equilibrium state is reached within four weeks and, for example, the concentration of oxygen in the barrier container 40 is less than 1%, the degradation of the liquid L as a chemical can be effectively suppressed. For a highly sensitive liquid L, the time to equilibrium is preferably within 20 days, more preferably within 1 week, still more preferably within 3 days. On the other hand, a certain period is required to reach an equilibrium state in which the amount of oxygen dissolved in the liquid L is reduced to some extent. The period or time from the closure of the barrier container 40 to the equilibrium of oxygen permeation through the container 30 may be 1 hour or more.

Adjustment of the amount of oxygen in the container 30 in the barrier container 40 may be performed until the oxygen permeation through the container 30 reaches equilibrium. Adjustment of the amount of oxygen in the container 30 in the barrier container 40 may be performed until the concentration of oxygen in the barrier container 40 increases to a predetermined value. Adjustment of the amount of oxygen in the container 30 in the barrier container 40 may be performed until the concentration of oxygen in the container 30 decreases to a predetermined value. Adjustment of the amount of oxygen in the container 30 in the barrier container 40 may be performed until the amount of oxygen dissolved in the liquid L in the container 30 decreases to a predetermined value. Adjustment of the amount of oxygen in the container 30 in the barrier container 40 may be performed until the liquid L in the combined container 10 is used. Furthermore, while the amount of oxygen is adjusted in the container 30 stored in the barrier container 40, the liquid-containing combined container 10L may be distributed.

Next, a method of using the liquid-containing combined container 10L is described.

When the liquid L in the combined container 10 is used, first, the barrier container 40 is opened. Next, the liquid-containing container 30L is taken out from the opened barrier container 40. The liquid L can then be taken out from the liquid-containing container 30L and used. The container 30 illustrated can be opened by removing the fixture 36 from the container body 32 and removing the stopper 34 from the container body 32. Thus, the liquid L in the container 30 can be used.

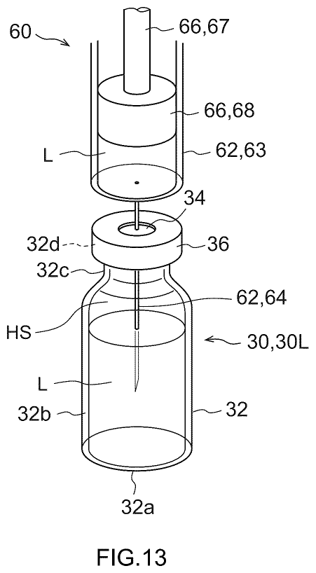

As illustrated in FIG. 13, the liquid L may be a chemical to be injected into a syringe 60. The liquid L may be a liquid in the container 30, which is a vial. The liquid L may be an injection among chemicals. The injection is, for example, an anticancer agent, an antiviral agent, a vaccine, an antipsychotic agent, or the like. The syringe 60 includes a cylinder 62 and a piston 66. The cylinder 62 includes a cylinder body 63 and a needle 64 protruding from the cylinder body 63. The tubular needle 64 allows access to the space of the cylinder body 63 for containing the liquid L. The piston 66 includes a piston body 67 and a gasket 68 held by the piston body 67. The gasket 68 may be composed of rubber or the like. The gasket 68 is inserted into the cylinder body 63 and defines the storage space for the liquid L in the cylinder body 63. The liquid L injected into the syringe 60 may be transferred from the syringe 60 to another syringe, a container, or the like before being administered to a patient or the like. In such an example, it may be administered to a patient from another syringe, a container, or the like.

The internal pressure of the liquid-containing container 30L is preferably adjusted. For example, the liquid-containing container 30L preferably has a low internal pressure, particularly a negative pressure. This example can effectively suppress unintended leakage of the liquid during storage of the liquid-containing container 30L, scattering of the liquid L when the container 30 is opened, or the like. The leakage or scattering problem is more severe with a toxic liquid, for example, a highly pharmacologically active chemical. In the example illustrated in FIG. 13, when the liquid-containing container 30L has a positive internal pressure, the liquid L automatically enters the syringe 60. In this case, it is difficult to accurately inject a desired amount of the liquid L into the syringe 60.

On the other hand, a highly sensitive liquid, for example, food or a chemical, more specifically, an anticancer agent, an antiviral agent, a vaccine, an antipsychotic agent, or the like, which is degraded by post-sterilization, for example, using gas, heat, gamma rays, or the like, after production is produced in a sterile environment and is enclosed in a container. Thus, a liquid to which terminal sterilization cannot be applied is produced by aseptic manipulation. This sterile environment is typically maintained at a predetermined positive pressure to suppress the entry of bacteria. Thus, the pressure in the container is a predetermined positive pressure corresponding to the sterile environment, and it is difficult to adjust the internal pressure of the container after the container is closed.

The present embodiment can solve such a problem. As described above, the liquid-containing container 30L is stored in the barrier container 40. During the storage, due to a decrease in the concentration of oxygen in the barrier container 40 caused by the deoxidizer 21 or a decrease in the concentration of oxygen in the barrier container 40 caused by inert gas replacement, oxygen in the container 30 permeates the container 30 and is transferred into the barrier container 40. This can reduce the pressure in the container 30. Thus, the pressure of the container 30 containing the liquid L can be adjusted after closing the container 30 to seal the liquid L.

From the perspective of adjusting the internal pressure of the container 30, the barrier container 40 that at atmospheric pressure can contain a gas maintained at a negative pressure may be used. For example, the barrier container 40 illustrated in FIG. 7 may be used, and the barrier container 40 storing the container 30 may be closed in an inert gas atmosphere maintained at a negative pressure. The pressure in the closed barrier container 40 is lower than the atmospheric pressure. In this case, oxygen permeation from the container 30 to the barrier container 40 is promoted. In particular, the pressure in the container 30 can be significantly adjusted by ensuring a large volume of the barrier container 40 or significantly reducing the initial pressure of the barrier container 40. Thus, in the container 30 stored in the barrier container 40, an initial positive pressure can be adjusted to a negative pressure. Thus, the pressure-adjusted liquid-containing container 30L can be produced irrespective of a method for producing the liquid L, a method of sealing the liquid L in the container 30, or the like.

Furthermore, closing the barrier container 40 at a negative pressure promotes oxygen permeation through the container 30. This can reduce the time from the closure of the barrier container 40 storing the liquid-containing container 30L to the equilibrium of oxygen permeation through the container 30.

The negative pressure refers to a pressure lower than the atmospheric pressure of 1 atm. The positive pressure refers to a pressure higher than the atmospheric pressure of 1 atm. When a container is provided with a pressure gauge, whether or not the pressure in the container is negative can be determined using the pressure gauge. When a container is not provided with a pressure gauge, the determination can be made using a syringe. More specifically, the determination can be made on the basis of whether or not a liquid or gas in a syringe flows into a target container in a state where only the atmospheric pressure is applied to a piston of the syringe when a needle of the syringe is inserted into the container. When the liquid or gas in the syringe flows into the container, it is determined that the pressure in the container is negative. Likewise, whether or not the pressure in the container is positive can be determined using a pressure gauge and can also be determined using a syringe. More specifically, the determination can be made on the basis of whether or not a liquid or gas in a target container flows into a syringe in a state where only the atmospheric pressure is applied to a piston of the syringe when a needle of the syringe is inserted into the container. When the liquid or gas in the container flows into the syringe, it is determined that the pressure in the container is positive.

In the embodiment described above, the container set 20 includes the container 30 that contains the liquid L and has oxygen permeability in at least a portion thereof and the barrier container 40 that can contain the container 30 and has an oxygen barrier property. The combined container 10 is produced by storing the container 30 in the barrier container 40. Thus, the liquid-containing combined container 10L includes the container 30 that contains the liquid L and has oxygen permeability in at least a portion thereof and the barrier container 40 that contains the container 30 and has an oxygen barrier property.

In the combined container 10, the barrier container 40 reduces the amount of oxygen and provides an oxygen barrier property. On the other hand, the liquid-containing container 30L may be responsible for the sterility of the interior and the contained liquid L. In this manner, the storage environment required for the liquid L is efficiently realized by the combination of the container 30 and the barrier container 40. The combined container 10 and the container set 20 can inexpensively and easily realize the preservation environment required for the liquid L with a high degree of freedom.

In a specific example of the embodiment described above, the container 30 includes the container body 32 with the opening portion 33 and the stopper 34 for closing the opening portion 33. The stopper 34 has oxygen permeability. In such a specific example, oxygen passes through the stopper 34 and out of the container 30. Thus, it is possible to impart oxygen permeability to a region exposed from the liquid L in the container 30, such as a so-called headspace HS. This smoothly promotes oxygen permeation through the container 30 and can reduce the time from the storage of the container 30 in the barrier container 40 to the equilibrium of oxygen permeation through the container 30.

In a specific example of the embodiment described above, the stopper 34 of the container 30 includes the stopper body portion 35 and the barrier layer 81. In such a specific example, while the barrier layer 81 suppresses a reaction of the liquid L in the container 30 with a material of the stopper 34, oxygen in the container 30 can be discharged to the outside of the container 30 through the stopper 34.

In a specific example of the embodiment described above, the container body 32 may have an oxygen barrier property. Oxygen that has permeated the container 30 enters a region separated from the liquid L, such as the headspace HS, in the container 30. This can suppress the dissolution of oxygen that has permeated the container 30 into the liquid L.

In a specific example of the embodiment described above, the opening portion 33 of the container body 32 may have an opening area of 10 mm² or more and 500 mm² or less. The stopper 34 may have a thickness of 0.1 mm or more and 5 mm or less. The liquid-containing combined container 10L can reduce the time from the storage of the container 30 in the barrier container 40 to the equilibrium of oxygen permeation through the container 30. This can suppress the decomposition of the liquid L by oxygen.

Although an embodiment has been described with reference to specific examples, the specific examples do not limit the embodiment. The embodiment can be implemented in various other specific examples, and various omissions, substitutions, modifications, additions, and the like can be made without departing from the gist of the embodiment.

An example of the modification is described below with reference to the accompanying drawings. In the following description and the drawings used in the following description, the same reference numerals and letters as those used for the corresponding portions in the specific examples are used for portions that can be configured in the same manner as in the specific examples, and redundant description is omitted.

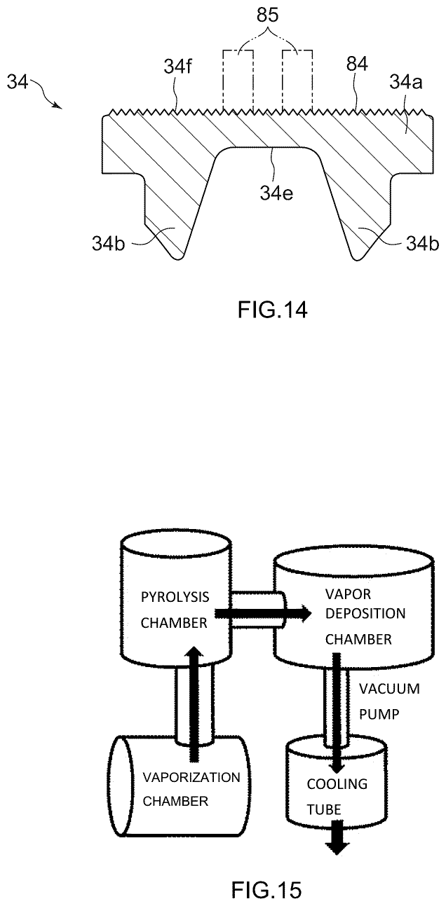

FIG. 14 is a view of an example of the stopper 34 of a modified example. FIG. 14 illustrates the external shape of the stopper 34 without illustrating the boundary between the stopper body portion 35 and the barrier layer 81 of the stopper 34 of the container 30. As illustrated in FIG. 14, an uneven surface 84 may be provided on at least part of the surface of the stopper 34. In particular, the uneven surface 84 may be provided on at least part of the surface of the stopper 34 that forms the outer surface of the liquid-containing container 30L. In the example illustrated in FIG. 14, the uneven surface 84 is provided on the second surface 34f of the plate-like portion 34a of the stopper 34. Since the uneven surface 84 is provided on at least part of the surface of the stopper 34, the surface area of the stopper 34 is larger than the surface area of the stopper 34 without the uneven surface 84 provided on the surface of the stopper 34. The stopper 34 with a large surface area can facilitate oxygen permeation through the stopper 34.

The uneven surface 84 can be formed, for example, by surface modification treatment, such as ion beam irradiation or plasma treatment, on the surface of the stopper 34. When the uneven surface 84 is provided on at least part of the surface of the stopper 34 that forms the outer surface of the liquid-containing container 30L, the surface of the stopper 34 on which the uneven surface 84 is provided may be constituted by the stopper body portion 35 or may be constituted by the barrier layer 81.

From the perspective of increasing the surface area of the stopper 34 to promote oxygen permeation, a protrusion 85 that protrudes from the outer surface of the stopper 34 may be provided. For example, as indicated by a dash-dot-dot line in FIG. 14, the stopper 34 may have the protrusion 85 not in contact with the container body 32.

### EXAMPLES

Although the embodiment is described in more detail below using examples, the embodiment is not limited to the examples.

### Example 1

In Example 1, the liquid-containing container 30L and the liquid-containing combined container 10L were produced by the following method, and the liquid-containing container 30L thus produced was tested.

### Production of Liquid-Containing Container

First, a vial with a volume of approximately 8.2 cm³ was prepared as the container 30. The container 30 had the structure illustrated in FIG. 1. The vial constituting the container 30 had a glass container body 32. The container 30 could contain a gas maintained at a negative pressure. Pure water was contained as the liquid L in the container 30. The amount of pure water was 4 cm³. The opening portion 33 of the container body 32 containing the liquid L was closed with the stopper 34.

The stopper 34 had the stopper body portion 35 composed of a silicone rubber and the barrier layer 81. A silicone rubber stopper was used as the stopper body portion 35. The silicone rubber forming the stopper body portion 35 had an oxygen permeability of 7.5×10⁴ (cm³/(m²·day·atm)). A portion of the stopper body portion 35 overlapping the opening portion 33 had a minimum thickness w1 of 2.7 mm. The stopper 34 had the structure illustrated in FIG. 4. More specifically, the barrier layer 81 had the first portion 81a and the second portion 81b and did not had the third portion 81c. The barrier layer 81 had a thickness of 200 nm. As described above, the stopper 34 of Example 1 had the structure illustrated in FIG. 4. In the stopper 34 of Example 1, therefore, the thickness of the barrier layer 81 is the thickness of the first portion 81a. The barrier layer 81 was a p-xylylene layer composed of p-xylylene N. The p-xylylene layer composed of p-xylylene N was a vapor-deposited film formed by a vapor deposition apparatus as illustrated in FIG. 15. The vapor deposition apparatus illustrated in FIG. 15 has a structure in which a vaporization chamber, a pyrolysis chamber, a vapor deposition chamber, and a vacuum pump are connected in order. The vapor deposition chamber and the vacuum pump are connected via a cooling tube.

More specifically, the p-xylylene layer composed of p-xylylene N was produced by a method including the following steps A to D using the vapor deposition apparatus described above.

Step A) A step of subjecting the surface of the stopper body portion 35 to plasma treatment by a reactive ion etching method or a direct plasma method in the presence of an argon/oxygen gas mixture in the pressure range of 1 to 100 Pa in the plasma power range of 10 to 500 W in the treatment time range of 5 to 500 seconds.

Step B) A step of introducing a p-xylylene compound, which is a material of the p-xylylene layer, into a vaporization chamber and vaporizing the compound at 100° C. to 160° C.

Step C) A step of converting the vaporized p-xylylene compound into radicals in a pyrolysis chamber at 600° C. to 690° C.

Step D) A step of introducing the p-xylylene compound radicals at 10 to 400 μbar into the vapor deposition chamber depressurized to 5 to 15 μbar and vapor-depositing and polymerizing the p-xylylene compound on the surface of the plasma-treated stopper body portion 35 separately introduced into the vapor deposition chamber to form a vapor-deposited film, which is a p-xylylene layer.

In the step B), the p-xylylene compound was introduced into the vaporization chamber, the vacuum pump was operated to adjust the vaporization chamber to a predetermined low pressure condition, and the vaporization chamber was then heated. Thus, the p-xylylene compound was vaporized.

An aluminum seal was fixed to the head 32d of the container body 32 using a hand clipper to produce the liquid-containing container 30L. The aluminum seal functioned as the fixture 36 illustrated in FIG. 2A. More specifically, the aluminum seal restricted the detachment of the stopper 34 from the container body 32. In the state after sealing with the aluminum seal, the space between the container body 32 and the stopper 34 was air-tight. In the container 30, the headspace HS not filled with water for injection remained with a volume of approximately 4.2 cm³. The container 30 was closed in the air. Thus, the headspace HS of the container 30 contained air. The concentration of oxygen in the headspace HS of the container 30 was 21.0%. The amount of oxygen dissolved in water for injection in the container 30 was 8.84 mg/L.

Next, the barrier container 40 composed of a transparent oxygen-barrier packaging material was prepared. The barrier container 40 had the structure illustrated in FIG. 1. The barrier container 40 was a so-called pouch. The deoxidizing member 22 including the liquid-containing container 30L and the deoxidizer 21 was stored in the barrier container 40, and the barrier container 40 was heat-sealed. Thus, the liquid-containing combined container 10L was produced. The sealed barrier container 40 contained approximately 100 cm³ of air. The deoxidizing member 22 contained the deoxidizer 21 that can absorb 200 cm³ of oxygen.

All materials, members, and the like used in Example 1 were sterilized. Storage of water for injection in the container 30, closure of the container 30, storage of the liquid-containing container 30L and the deoxidizer 21 in the barrier container 40, and closure of the barrier container 40 were performed in an isolator under sterile conditions.

### Test to Measure Oxygen permeation amount of Stopper

The oxygen permeation amount of the stopper 34 of the liquid-containing container 30L of Example 1 measured by the method illustrated in FIG. 2B was 2.1 (cm³/(day·atm)). The stopper 34 of Example 1 was determined to have oxygen permeability.

### Liquid Leakage Test

The liquid-containing container 30L of Example 1 was subjected to the liquid leakage test. First, as described above, the liquid-containing container 30L containing 4 cm³ of pure water as the liquid L and having the opening portion 33 closed by the stopper 34 was prepared. A beaker containing a stain liquid was also prepared. The liquid-containing container 30L was then placed in the beaker and was submerged below the surface of the stain liquid in the beaker. The beaker was then placed in a desiccator with a function of reducing the pressure in the desiccator. The pressure of the atmosphere around the beaker was then reduced by 30 kPa from atmospheric pressure for 10 minutes to reduce the pressure in the liquid-containing container 30L. The pressure of the atmosphere around the beaker was then returned to atmospheric pressure and was allowed to stand for 30 minutes. Whether the liquid L in the container 30 was dyed with the stain liquid was then observed. When the liquid L in the container 30 was dyed with the stain liquid, it was determined that the stopper 34 did not seal the liquid L. When the liquid L in the container 30 was not dyed with the stain liquid, it was determined that the stopper 34 sealed the liquid L.

### Example 2

In Example 2, the liquid-containing container 30L and the liquid-containing combined container 10L were produced in the same manner as in Example 1 except that the barrier layer 81 had a thickness of 500 nm, and the liquid-containing container 30L thus produced was tested. The stopper 34 of Example 2 had an oxygen permeation amount of 1.9 (cm3/(day·atm)). The stopper 34 of Example 2 was determined to have oxygen permeability.

### Example 3

In Example 3, the liquid-containing container 30L and the liquid-containing combined container 10L were produced in the same manner as in Example 1 except that the barrier layer 81 had a thickness of 1000 nm, and the liquid-containing container 30L thus produced was tested. The stopper 34 of Example 3 had an oxygen permeation amount of 1.5 (cm³/(day·atm)). The stopper 34 of Example 3 was determined to have oxygen permeability.

### Example 4

In Example 4, the liquid-containing container 30L and the liquid-containing combined container 10L were produced in the same manner as in Example 1 except that the barrier layer 81 had a thickness of 3000 nm, and the liquid-containing container 30L thus produced was tested. The stopper 34 of Example 4 had an oxygen permeation amount of 0.9 (cm³/(day·atm)). The stopper 34 of Example 4 was determined to have oxygen permeability.

### Comparative Example 1

In Comparative Example 1, the liquid-containing container 30L and the liquid-containing combined container 10L were produced in the same manner as in Example 1 except that the barrier layer 81 had a thickness of 50000 nm, and the liquid-containing container 30L thus produced was tested. The stopper 34 of Comparative Example 1 had an oxygen permeation amount of less than 0.1 (cm³/(day·atm)). The stopper 34 of Comparative Example 1 was determined to have no oxygen permeability.

### Comparative Example 2

In Comparative Example 2, the liquid-containing container 30L and the liquid-containing combined container 10L were produced in the same manner as in Example 1 except that the stopper 34 did not have the barrier layer 81, and the liquid-containing container 30L thus produced was tested.

Table 1 shows the test results of the liquid-containing containers 30L of Examples 1 to 3 and Comparative Examples 1 and 2 together with the thickness of the barrier layer 81. In the column “Test to measure oxygen permeation amount of stopper”, “Good” means that the stopper 34 was determined to have oxygen permeability and had an oxygen permeation amount of 1 (cm³/(day·atm)) or more. In the column “Test to measure oxygen permeation amount of stopper”, “Fair” means that the stopper 34 was determined to have oxygen permeability and had an oxygen permeation amount of 0.1 (cm³/(day·atm)) or more and less than 1 (cm³/(day·atm)). In the column “Test to measure oxygen permeation amount of stopper”, “Poor” means that the stopper 34 was determined to have no oxygen permeability. In the liquid leakage evaluation test, “Good” means that the stopper 34 was determined to seal the liquid L. In the liquid leakage evaluation test, “Poor” means that the stopper 34 was determined not to seal the liquid L.

TABLE 1

| | Example | Example | Example | Example | Comparative | Comparative |
|---|---|---|---|---|---|---|
| | 1 | 2 | 3 | 4 | example 1 | example 2 |
| Test to measure | Good | Good | Good | Fair | Poor | Good |
| oxygen permeation | | | | | | |
| amount of stopper | | | | | | |
| Liquid leakage test | Good | Good | Good | Good | Poor | Good |
| Thickness of barrier | 200 | 500 | 1000 | 3000 | 50000 | — |
| layer (nm) | | | | | | |

As shown in Table 1, the stopper 34 with oxygen permeability was produced in Examples 1 to 3 in which the barrier layer 81 had a thickness of 1000 nm or less in the test to measure the oxygen permeation amount of the stopper 34.

As shown in Table 1, in the liquid leakage evaluation test, the stopper 34 was determined to seal the liquid L in Examples 1 to 3 in which the barrier layer 81 had a thickness of 1000 nm or less. On the other hand, in Comparative Example 1 in which the barrier layer 81 had a thickness of 1200 nm, the stopper 34 was determined not to seal the liquid L. Thus, it has been found that when the stopper 34 had the structure illustrated in FIG. 4, the barrier layer 81 with a thickness of 1000 nm or less could more effectively prevent leakage of the liquid L from the container 30.

### Example 5

In Example 5, the liquid-containing container 30L and the liquid-containing combined container 10L were produced in the same manner as in Example 1 except for the following points, and the liquid-containing container 30L thus produced was tested. The barrier layer 81 was a fluoropolymer layer composed of a perfluoroalkoxy alkane (PFA). The fluoropolymer layer composed of the perfluoroalkoxy alkane (PFA) was produced by laminating a PFA film on the stopper body portion 35. The barrier layer 81 had a thickness of 10 μm. The stopper 34 of Example 5 had an oxygen permeation amount of 1.1 (cm³/(day·atm)). The stopper 34 of Example 5 was determined to have oxygen permeability.

### Example 6

In Example 6, the liquid-containing container 30L and the liquid-containing combined container 10L were produced in the same manner as in Example 5 except that the barrier layer 81 had a thickness of 20 μm, and the liquid-containing container 30L thus produced was tested. The stopper 34 of Example 6 had an oxygen permeation amount of 0.6 (cm³/(day·atm)). The stopper 34 of Example 6 was determined to have oxygen permeability.

### Example 7

In Example 7, the liquid-containing container 30L and the liquid-containing combined container 10L were produced in the same manner as in Example 5 except that the barrier layer 81 had a thickness of 50 μm, and the liquid-containing container 30L thus produced was tested. The stopper 34 of Example 7 had an oxygen permeation amount of 0.3 (cm³/(day·atm). The stopper 34 of Example 7 was determined to have oxygen permeability.

### Example 8

In Example 8, the liquid-containing container 30L and the liquid-containing combined container 10L were produced in the same manner as in Example 5 except that the barrier layer 81 had a thickness of 100 μm, and the liquid-containing container 30L thus produced was tested. The stopper 34 of Example 8 had an oxygen permeation amount of 0.15 (cm³/(day·atm)). The stopper 34 of Example 8 was determined to have oxygen permeability.

### Comparative Example 3

In Comparative Example 3, the liquid-containing container 30L and the liquid-containing combined container 10L were produced in the same manner as in Example 5 except that the barrier layer 81 had a thickness of 200 μm, and the liquid-containing container 30L thus produced was tested. The stopper 34 of Comparative Example 3 had an oxygen permeation amount of less than 0.1 (cm³/(day·atm)). The stopper 34 of Comparative Example 3 was determined to have no oxygen permeability.

Table 2 shows the test results of the liquid-containing containers 30L of Examples 5 to 8 and Comparative Example 3 together with the thickness of the barrier layer 81. Table 2 also shows the test results of the liquid-containing container 30L of Comparative Example 2. “Good”, “Poor”, and “Fair” in Table 2 have the same meanings as in Table 1.

TABLE 2

| | Example | Example | Example | Example | Comparative | Comparative |
|---|---|---|---|---|---|---|
| | 5 | 6 | 7 | 8 | example 3 | example 2 |
| Test to measure | Good | Fair | Fair | Fair | Poor | Good |
| oxygen permeation | | | | | | |
| amount of stopper | | | | | | |
| Liquid leakage test | Good | Good | Good | Good | Poor | Good |
| Thickness of barrier | 10 | 20 | 50 | 100 | 200 | — |
| layer (μm) | | | | | | |

As shown in Table 2, the stopper 34 with oxygen permeability was produced in Examples 4 to 6 in which the barrier layer 81 had a thickness of 50 um or less in the test to measure the oxygen permeation amount of the stopper 34.

As shown in Table 2, in the liquid leakage evaluation test, the stopper 34 was determined to seal the liquid L in Examples 4 to 6 in which the barrier layer 81 had a thickness of 50 μm or less. On the other hand, in Comparative Example 3 in which the barrier layer 81 had a thickness of 100 μm, the stopper 34 was determined not to seal the liquid L. Thus, it has been found that when the stopper 34 had the structure illustrated in FIG. 4, the barrier layer 81 with a thickness of 50 μm or less could more effectively prevent leakage of the liquid L from the container 30.

### Example 9

In Example 9, the liquid-containing container 30L and the liquid-containing combined container 10L were produced in the same manner as in Example 1 except for the following points. The barrier layer 81 was a p-xylylene layer composed of p-xylylene HT. The p-xylylene layer composed of p-xylylene HT was produced by the same method as the method for producing the p-xylylene layer composed of p-xylylene N in Example 1. The barrier layer 81 had a thickness of 1000 nm. The stopper 34 of the liquid-containing container 30L thus produced was subjected to an oxygen permeability test in the same manner as in Example 1. The stopper 34 of Example 9 had an oxygen permeation amount of 2.0 (cm³/(day·atm)). The stopper 34 of Example 9 was determined to have oxygen permeability.

### Comparative Example 4

In Comparative Example 4, the liquid-containing container 30L and the liquid-containing combined container 10L were produced in the same manner as in Example 9 except that the barrier layer 81 had a thickness of 50000 nm, and the liquid-containing container 30L thus produced was tested. The stopper 34 of Comparative Example 4 had an oxygen permeation amount of less than 0.1 (cm³/(day·atm)). The stopper 34 of Comparative Example 4 was determined to have no oxygen permeability.

Table 3 shows the test results of the liquid-containing container 30L of Example 9 and Comparative Example 4 together with the thickness of the barrier layer 81. “Fair” and “Poor” in Table 3 have the same meanings as in Table 1.

TABLE 3

| | | Comparative |
|---|---|---|
| | Example 9 | example 4 |
| Test to measure oxygen | Good | Poor |
| permeation amount of stopper | | |
| Thickness of barrier | 1000 | 50000 |
| layer (nm) | | |

As shown in Table 3, the stopper 34 with oxygen permeability was produced in Example 9 in which the barrier layer 81 had a thickness of 1000 nm or less in the test to measure the oxygen permeation amount of the stopper 34.

### Example 10

In Example 10, a stopper 34 similar to the stopper 34 of the liquid-containing container 30L of Example 1 was produced in the same manner as in Example 1 except for the following points. As the stopper 34 of Example 10, a stopper 34 with the structure illustrated in FIG. 3 was produced. The barrier layer 81 of the stopper 34 included a first portion 81a, a second portion 81b, and a third portion 81c. The entire surface of the stopper body portion 35 was covered with the barrier layer 81. The barrier layer 81 had a thickness of 400 nm. As described above, the stopper 34 of Example 10 had the structure illustrated in FIG. 3. In the stopper 34 of Example 10, therefore, the thickness of the barrier layer 81 is the total thickness of the first portion 81a and the third portion 81c. The thickness of the barrier layer 81 was uniform in the first portion 81a, the second portion 81b, and the third portion 81c. Each of the first portion 81a, the second portion 81b, and the third portion 81c had a thickness of 200 nm.

### Test to Measure Oxygen Permeation Amount of Stopper

When the oxygen permeation amount of the stopper 34 of Example 10 was measured by the method illustrated in FIG. 2B, the stopper 34 of Example 10 was determined to have oxygen permeability.

### Activity Level Evaluation Test

The stopper 34 of Example 10 was subjected to an activity level evaluation test of evaluating the activity level of a liquid brought into contact with the stopper 34 as described below. The activity level evaluation test was an eluate test in Test for rubber closure for aqueous infusions specified in The Japanese Pharmacopoeia 18th edition. In particular, in the eluate test, an ultraviolet absorption spectrum test was conducted. First, a heat-resistant glass container that can store the stopper 34 was prepared. Next, the stopper 34 and pure water were placed in the heat-resistant glass container, and the heat-resistant glass container was closed. The amount of pure water in the heat-resistant glass container was adjusted to be 2γ cm³ when the stopper 34 had a total surface area of γ cm². The stopper 34 had a total surface area of approximately 8.6 cm². Thus, the amount of pure water was 17.2 cm³. The heat-resistant glass container containing the stopper 34 and the pure water was then subjected to high-pressure steam sterilization at 121° C. for 1 hour. The heat-resistant glass container was then allowed to stand at room temperature until the temperature reached room temperature. The stopper 34 was then quickly removed from the heat-resistant glass container, and the liquid in the heat-resistant glass container was used as a test liquid.

A blank test liquid was prepared by the following method. 17.2 cm3 of pure water was enclosed in a heat-resistant glass container similar to the heat-resistant glass container containing the stopper 34 and the pure water. The heat-resistant glass container containing the pure water was then subjected to high-pressure steam sterilization in the same manner as the heat-resistant glass container containing the stopper 34 and the pure water. The liquid in the heat-resistant glass container was used as a blank test liquid.

The test liquid was then tested by an ultraviolet-visible absorbance measurement method specified in The Japanese Pharmacopoeia 18th edition using the blank test liquid as a control, and the absorbance of a silicone-derived component was measured. More specifically, the absorbance of the silicone-derived component was measured by the following method. The absorbance of the test liquid prepared for the stopper 34 was measured in the wavelength range of 220 nm to 350 nm. A layer similar to the barrier layer 81 was provided on a glass plate with a surface area similar to that of the stopper body portion 35 by a method similar to the method of providing the barrier layer 81 on the stopper body portion 35. The glass plate provided with the layer similar to the barrier layer 81 was then subjected to the same test as that performed on the stopper 34, that is, the eluate test of the Test for rubber closure for aqueous infusions specified in The Japanese Pharmacopoeia 18th edition, to prepare a test liquid. The test liquid prepared for the glass plate was then tested by the ultraviolet-visible absorbance measurement method specified in The Japanese Pharmacopoeia 18th edition to measure the absorbance in the wavelength range of 220 nm to 350 nm. A value obtained by subtracting the measurement result of the absorbance in the wavelength range of 220 nm to 350 nm of the test liquid prepared for the glass plate from the measurement result of the absorbance in the wavelength range of 220 nm to 350 nm of the test liquid prepared for the stopper 34 was regarded as the absorbance of the silicone-derived component in the stopper body portion 35.

When the measured absorbance of the silicone-derived component is relatively high, it is thought that the eluate from the stopper body portion 35 is eluted into the liquid in contact with the stopper 34 in the high-pressure steam sterilization, and the liquid therefore has a relatively high activity level. In this case, the barrier layer 81 is considered to have a small effect of suppressing the elution of the eluate from the stopper body portion 35 into the liquid L in a storage portion 31. When the measured absorbance of the silicone-derived component is relatively low, the liquid in contact with the stopper 34 is considered to have a relatively low activity level. In this case, the barrier layer 81 is considered to have a large effect of suppressing the elution of the eluate from the stopper body portion 35 into the liquid L.

### Example 11

In Example 11, the stopper 34 was produced in the same manner as in Example 10 except that the barrier layer 81 had a thickness of 1000 nm and each of the first portion 81a, the second portion 81b, and the third portion 81c had a thickness of 500 nm, and the stopper 34 thus produced was tested. The stopper 34 of Example 11 was determined to have oxygen permeability.

### Example 12

In Example 12, the stopper 34 was produced in the same manner as in Example 10 except that the barrier layer 81 had a thickness of 2000 nm and each of the first portion 81a, the second portion 81b, and the third portion 81c had a thickness of 1000 nm, and the stopper 34 thus produced was tested. The stopper 34 of Example 12 was determined to have oxygen permeability.

### Example 13

In Example 13, the stopper 34 was produced in the same manner as in Example 10 except that the barrier layer 81 had a thickness of 2400 nm and each of the first portion 81a, the second portion 81b, and the third portion 81c had a thickness of 1200 nm, and the stopper 34 thus produced was tested. The stopper 34 of Example 13 was determined to have oxygen permeability.

### Example 14

In Example 14, the stopper 34 was produced in the same manner as in Example 10 except that the barrier layer 81 had a thickness of 6000 nm and each of the first portion 81a, the second portion 81b, and the third portion 81c had a thickness of 3000 nm, and the stopper 34 thus produced was tested. The stopper 34 of Example 14 was determined to have oxygen permeability.

Table 4 shows the test results of the stoppers 34 of Examples 10 to 14 together with the thickness of the barrier layer 81 and the thickness of the first portion 81a. The stopper 34 of the liquid-containing container 30L of Comparative Example 2 described above was subjected to the activity level evaluation test in the same manner as in Example 10, and the test results of Comparative Example 2 are also shown in Table 4. “Good”, “Poor”, and “Fair” in the column “Test to measure oxygen permeation amount of stopper” in Table 4 have the same meanings as in the column “Test to measure oxygen permeation amount of stopper” in Table 1. In the activity level evaluation test, “Good” means that the silicone-derived component had an absorbance lower than that in Comparative Example 2. In the activity level evaluation test, “Poor” means that the silicone-derived component had an absorbance equal to or higher than that in Comparative Example 2.

TABLE 4

| | Example | Example | Example | Example | Example | Comparative |
|---|---|---|---|---|---|---|
| | 10 | 11 | 12 | 13 | 14 | example 2 |
| Test to measure | Good | Good | Good | Good | Fair | Good |
| oxygen permeation | | | | | | |
| amount of stopper | | | | | | |
| Activity level | Good | Good | Good | Good | Good | Poor |
| evaluation test | | | | | | |
| Thickness of | 400 | 1000 | 2000 | 2400 | 6000 | — |
| barrier layer (nm) | | | | | | |
| Thickness of first | 200 | 500 | 1000 | 1200 | 3000 | — |
| portion (nm) | | | | | | |

As shown in Table 4, in the activity level evaluation test, the test results were “Good” in Examples 10 to 14 with the barrier layer 81. More specifically, the silicone-derived component had an absorbance lower than that in Comparative Example 2. Thus, it was found that the stopper 34 with the barrier layer 81 could suppress the elution of the eluate from the stopper body portion 35 into the liquid L.

The first portion 81a of the stopper 34 of Example 10 has the same thickness as the first portion 81a of the stopper 34 of Example 1. The first portion 81a of the stopper 34 of Example 11 has the same thickness as the first portion 81a of the stopper 34 of Example 2. The first portion 81a of the stopper 34 of Example 12 has the same thickness as the first portion 81a of the stopper 34 of Example 3. The first portion 81a of the stopper 34 of Example 14 has the same thickness as the first portion 81a of the stopper 34 of Example 4. Furthermore, when the stopper 34 closes the opening portion 33 of the container body 32 as illustrated in FIGS. 3 to 5B, the first portion 81a of the barrier layer 81 suppresses the elution of the eluate from the stopper body portion 35 into the liquid L in a storage portion 31. Thus, it is thought that the stoppers 34 of Examples 1 to 4 in which the thickness of the first portion 81a is the same as that in any one of the stoppers 34 of Examples 10, 11, 12, and 14 can also suppress the elution of the eluate from the stopper body portion 35 into the liquid L.

### Example 15

In Example 15, the stopper 34 was produced in the same manner as in Example 10 except for the following points, and the stopper 34 thus produced was tested. The barrier layer 81 was a fluoropolymer layer composed of a perfluoroalkoxy alkane (PFA). The fluoropolymer layer composed of the perfluoroalkoxy alkane (PFA) was produced by laminating a PFA film on the stopper body portion 35. The barrier layer 81 had a thickness of 20 μm. Each of the first portion 81a, the second portion 81b, and the third portion 81c had a thickness of 10 μm. The stopper 34 of Example 15 was determined to have oxygen permeability.

### Example 16

In Example 16, the stopper 34 was produced in the same manner as in Example 15 except that the barrier layer 81 had a thickness of 40 μm and each of the first portion 81a, the second portion 81b, and the third portion 81c had a thickness of 20 μm, and the stopper 34 thus produced was tested. The stopper 34 of Example 16 was determined to have oxygen permeability.

### Example 17

In Example 17, the stopper 34 was produced in the same manner as in Example 15 except that the barrier layer 81 had a thickness of 100 μm and each of the first portion 81a, the second portion 81b, and the third portion 81c had a thickness of 50 μm, and the stopper 34 thus produced was tested. The stopper 34 of Example 17 was determined to have oxygen permeability.

### Comparative Example 5

In Comparative Example 5, the stopper 34 was produced in the same manner as in Example 15except that the barrier layer 81 had a thickness of 200 μm and each of the first portion 81a, the second portion 81b, and the third portion 81c had a thickness of 100 μm, and the stopper 34 thus produced was tested. The stopper 34 of Comparative Example 5 was determined to have no oxygen permeability.

Table 5 shows the test results of the stoppers 34 of Examples 15 to 17 and Comparative Example 5 together with the thickness of the barrier layer 81 and the thickness of the first portion 81a. The test results of Comparative Example 2 were also shown in Table 5. “Good”, “Poor”, and “Fair” in Table 5 have the same meanings as in Table 4.

TABLE 5

| | Example | Example | Example | Comparative | Comparative |
|---|---|---|---|---|---|
| | 15 | 16 | 17 | example 5 | example 2 |
| Test to | Fair | Fair | Fair | Poor | Good |
| measure | | | | | |
| oxygen | | | | | |
| permeation | | | | | |
| amount of | | | | | |
| stopper | | | | | |
| Activity | Good | Good | Good | Good | Poor |
| level | | | | | |
| evaluation | | | | | |
| test | | | | | |
| Thickness | 20 | 40 | 100 | 200 | — |
| of barrier | | | | | |
| layer (μm) | | | | | |
| Thickness | 10 | 20 | 50 | 100 | — |
| of first | | | | | |
| portion (μm) | | | | | |

As shown in Table 5, in the activity level evaluation test, the test results were “Good” in Examples 15 to 17 and Comparative Example 5 with the barrier layer 81. More specifically, the silicone-derived component had an absorbance lower than that in Comparative Example 2. Thus, it was found that the stopper 34 with the barrier layer 81 could suppress the elution of the eluate from the stopper body portion 35 into the liquid L.

The first portion 81a of the stopper 34 of Example 15 has the same thickness as the first portion 81a of the stopper 34 of Example 5. The first portion 81a of the stopper 34 of Example 16 has the same thickness as the first portion 81a of the stopper 34 of Example 6. The first portion 81a of the stopper 34 of Example 17 has the same thickness as the first portion 81a of the stopper 34 of Example 7. The first portion 81a of the stopper 34 of Comparative Example 5 has the same thickness as the first portion 81a of the stopper 34 of Example 8. Furthermore, when the stopper 34 closes the opening portion 33 of the container body 32 as illustrated in FIGS. 3 to 5B, the first portion 81a of the barrier layer 81 suppresses the elution of the eluate from the stopper body portion 35 into the liquid L in a storage portion 31. Thus, it is thought that the stoppers 34 of Examples 4 to 8 in which the thickness of the first portion 81a is the same as that in any one of the stoppers 34 of Examples 15 to 17 and Comparative Example 5 can also suppress the elution of the eluate from the stopper body portion 35 into the liquid L.

### Example 18

In Example 18, the stopper 34 was produced in the same manner as in Example 10 except for the following points. The barrier layer 81 had a thickness of 400 nm. Each of the first portion 81a, the second portion 81b, and the third portion 81c had a thickness of 200 nm.

### Test to Measure Oxygen Permeation Amount of Stopper

The oxygen permeation amount of the stopper 34 of the liquid-containing container 30L of Example 18 measured by the method illustrated in FIG. 2C was 2.91 (cm³/(day·atm)). The stopper 34 of Example 18 was determined to have oxygen permeability.

### Example 19

In Example 19, the stopper 34 was produced in the same manner as in Example 18 except for the following points, and the stopper 34 thus produced was tested. The barrier layer 81 had a thickness of 1000 nm. Each of the first portion 81a, the second portion 81b, and the third portion 81c had a thickness of 500 nm. As a result of measuring the oxygen permeation amount of the stopper 34 by the method illustrated in FIG. 2C, the stopper 34 of Example 19 was determined to have oxygen permeability.

### Example 20

In Example 20, the stopper 34 was produced in the same manner as in Example 18 except for the following points, and the stopper 34 thus produced was tested. The barrier layer 81 had a thickness of 2000 nm. Each of the first portion 81a, the second portion 81b, and the third portion 81c had a thickness of 1000 nm. As a result of measuring the oxygen permeation amount of the stopper 34 by the method illustrated in FIG. 2C, the stopper 34 of Example 20 was determined to have oxygen permeability.

### Comparative Example 6

In Comparative Example 6, the stopper 34 was produced in the same manner as in Example 18 except that the stopper 34 did not have the barrier layer 81, and the stopper 34 thus produced was tested.

Table 6 shows the test results of the liquid-containing containers 30L of Examples 18 to 20 and Comparative Example 6 together with the thickness of the barrier layer 81.

TABLE 6

| | Example | Example | Example | Comparative |
|---|---|---|---|---|
| | 18 | 19 | 20 | example 6 |
| Test to measure oxygen | 2.91 | 2.46 | 2.25 | 3.29 |
| permeation amount of | | | | |
| stopper | | | | |
| (cm³/(day · atm)) | | | | |
| Thickness of barrier | 400 | 1000 | 2000 | — |
| layer (nm) | | | | |

The results of the test to measure the oxygen permeation amount of the stopper shown in Table 6 showed that the oxygen permeation amount of the stopper 34 can be 2 (cm³/(day·atm)) or more, particularly 2.2 (cm³/(day·atm)) or more, while providing the barrier layer 81. It was also found that the oxygen permeation amount of the stopper 34 tends to decrease as the thickness of the barrier layer 81 increases.

### Example 21

In Example 21, the stopper 34 was produced in the same manner as in Example 1 except for the following points. As the stopper 34 of Example 21, a stopper 34 with the structure illustrated in FIG. 3 was produced. The barrier layer 81 of the stopper 34 included a first portion 81a, a second portion 81b, and a third portion 81c. The entire surface of the stopper body portion 35 was covered with the barrier layer 81. The barrier layer 81 had a thickness of 400 nm. As described above, the stopper 34 of Example 21 had the structure illustrated in FIG. 3. In the stopper 34 of Example 21, therefore, the thickness of the barrier layer 81 is the total thickness of the first portion 81a and the third portion 81c. The thickness of the barrier layer 81 was uniform in the first portion 81a, the second portion 81b, and the third portion 81c. Each of the first portion 81a, the second portion 81b, and the third portion 81c had a thickness of 200 nm.

### Storage Test of Infliximab

Using the stopper 34 produced in Example 21, the liquid-containing container 30L was produced in the same manner as in Example 1 except for the following points. Commercially available infliximab (manufactured by Pfizer Inc.) dissolved in water at a concentration of 2 mg/ml (at a concentration of 0.2% by mass) was contained as the liquid L. The amount of the liquid was 1 cm³. A plurality of liquid-containing containers 30L containing the liquid L containing infliximab were produced by the method described above and were placed under the following two conditions 1 and 2.

Under the condition 1, the liquid-containing containers 30L were stood on a flat surface with the second surface 34f of the stopper 34 facing downward and were left in this state for 4 weeks. The temperature around the liquid-containing containers 30L left was 40° C. Two of the produced liquid-containing containers 30L were placed under the condition 1.

Under the condition 2, the liquid-containing containers 30L were stood on a flat surface with the second surface 34f of the stopper 34 facing downward and were left in this state for 4 weeks. The temperature around the liquid-containing containers 30L left was 40° C. An impact test of applying an impact to the liquid-containing container 30L was then performed. In the impact test, a test of applying an impact by dropping the liquid-containing container 30L was performed using a tablet friability tester (TFT-1200 manufactured by Toyama Sangyo Co., Ltd.). In the impact test, the rotational speed was 50 rpm, and the number of drops was 500.

The liquid L was taken out from each of the liquid-containing containers 30L placed under the two conditions 1 and 2 and was analyzed by size-exclusion chromatography. An apparatus for size-exclusion chromatography analysis was a product name “Agilent InfinityLab 1260 Bioinert LC” manufactured by Agilent Technologies, Inc. The liquid L taken out from each of the two liquid-containing containers 30L placed under the condition 1 was analyzed by size-exclusion chromatography.

### Storage Test of Bevacizumab

Using the stopper 34 produced in Example 21, the liquid-containing container 30L was produced in the same manner as in Example 1 except for the following points. Commercially available bevacizumab (manufactured by Pfizer Inc.) dissolved in water at a concentration of 2 mg/ml (at a concentration of 0.2% by mass) was contained as the liquid L. The amount of the liquid was 1 cm³. A plurality of liquid-containing containers 30L containing the liquid L containing bevacizumab were produced by the method described above and were placed under the two conditions 1 and 2 described above in the storage test of infliximab. Two of the produced liquid-containing containers 30L were placed under the condition 1.

The liquid L was taken out from each of the liquid-containing containers 30L placed under the two conditions 1 and 2 and was analyzed by size-exclusion chromatography. An apparatus for size-exclusion chromatography analysis was the same apparatus as that described above in the storage test of infliximab. The liquid L taken out from each of the two liquid-containing containers 30L placed under the condition 1 was analyzed by size-exclusion chromatography.

### Comparative Example 7

In Comparative Example 7, the stopper 34 was produced in the same manner as in Example 21 except that the stopper 34 did not have the barrier layer 81. The stopper 34 produced in Comparative Example 7 was subjected to the storage test of infliximab and the storage test of bevacizumab in the same manner as in Example 21.

Table 7 shows some of the results of the storage test of infliximab in the liquid-containing containers 30L of Example 21 and Comparative Example 7. Among the test results of the liquid-containing containers 30L of Example 21 and Comparative Example 7, the test results of the two liquid-containing containers 30L placed under the condition 1 in the storage test of infliximab are shown in the columns “Sample N1” and “Sample N2” in Table 7. The column “Peak area” in Table 7 shows the area of a peak considered to correspond to a monomer that is a main component of infliximab in a chromatogram obtained by size-exclusion chromatography analysis. The column “Area %” in Table 7 shows the ratio of the area of a peak considered to correspond to a monomer that is a main component of infliximab to the total area of peaks detected in a chromatogram obtained by size-exclusion chromatography analysis. The column “Average peak area” in Table 7 shows the average value of the areas of a peak considered to correspond to a monomer that is a main component of infliximab in “Sample N1” and “Sample N2”.

TABLE 7

| | Sample N1 | | Sample N2 | | Average |
|---|---|---|---|---|---|
| | Peak area | Area % | Peak area | Area % | peak area |
| Example 21 | 9496.224 | 100 | 9953.424 | 100 | 9724.824 |
| Comparative | 7863.594 | 100 | 8767.082 | 100 | 8315.338 |
| example 7 | | | | | |

As shown in Table 7, as a result of the size-exclusion chromatography analysis of the liquid L taken out from the liquid-containing container 30L placed under the condition 1, it was found that the peak area of the peak considered to correspond to the monomer that is the main component of infliximab was larger in Example 21 than in Comparative Example 7. This result can be interpreted as follows. In Comparative Example 7, it is thought that a material, particularly the silicone rubber, in the stopper adsorbed the main component of infliximab and thereby reduced the concentration of the main component of infliximab in the liquid L and reduced the peak area. In contrast, in Example 21, it is thought that the barrier layer 81 suppressed the adsorption of the main component of infliximab to a material of the stopper body portion 35 and prevented the decrease in the concentration of the main component of infliximab in the liquid L and secured the large peak area.

Table 8 shows some of the results of the storage test of bevacizumab in the liquid-containing containers 30L of Example 21 and Comparative Example 7. Among the test results of the liquid-containing containers 30L of Example 21 and Comparative Example 7, the test results of the two liquid-containing containers 30L placed under the condition 1 in the storage test of bevacizumab are shown in the columns “Sample N1” and “Sample N2” in Table 8. The column “Peak area” in Table 8 shows the area of a peak considered to correspond to a monomer that is a main component of bevacizumab in a chromatogram obtained by size-exclusion chromatography analysis.

TABLE 8

| | Sample N1 | Sample N2 |
|---|---|---|
| | Peak area | Peak area |
| Example 21 | 6788.487 | 9997.448 |
| Comparative | 5634.531 | 7678.062 |
| example 7 | | |

In the storage study of bevacizumab, the size-exclusion chromatography analysis of the liquid L taken out from the liquid-containing container 30L placed under the condition 1 showed the following. As shown in Table 8, it was found that the peak area of the peak considered to correspond to the monomer that is the main component of bevacizumab was larger in Example 21 than in Comparative Example 7. It was found that the peak area of the peak considered to correspond to the monomer that is the main component of bevacizumab was larger in Example 21 than in Comparative Example 7. This result can be interpreted as follows. In Comparative Example 7, it is thought that a material, particularly the silicone rubber, in the stopper adsorbed the main component of bevacizumab and thereby reduced the concentration of the main component of bevacizumab in the liquid L and reduced the peak area. In contrast, in Example 21, it is thought that the barrier layer 81 suppressed the adsorption of the main component of bevacizumab to a material of the stopper body portion 35 and prevented the decrease in the concentration of the main component of bevacizumab in the liquid L and secured the large peak area. Furthermore, in the storage study of bevacizumab, the size-exclusion chromatography analysis of the liquid L taken out from the liquid-containing container 30L placed under the condition 2 showed the following. It was found that, in Example 21, formation of an aggregate due to aggregation of a monomer that is a main component of bevacizumab tended to be suppressed as compared with Comparative Example 7. This result can be interpreted as follows. In Comparative Example 7, it is thought that the liquid L came into contact with a material, particularly the silicone rubber, in the stopper, and the main component of bevacizumab was aggregated by the influence of the silicone rubber and formed an aggregate. It is also thought that the progress of the aggregation of the main component of bevacizumab reduced the concentration of the main component of bevacizumab in the liquid L and reduced the peak intensity. In contrast, in Example 21, it is thought that the barrier layer 81 suppressed the contact between the liquid L and the material of the stopper body portion 35, suppressed the aggregation of the main component of bevacizumab, and secured the high peak intensity.

### REFERENCE SIGNS LIST

10L liquid-containing combined container, 10 combined container, 20 container set, 21 deoxidizer, 30L liquid-containing container, 30 container, 32 container body, 33 opening portion, 34 stopper, 35 stopper body portion, 36 fixture, 40 barrier container, 40a opening, 41a first main film, 41b second main film, 41c first gusset film, 41d second gusset film, 42 container body, 42a storage portion, 42b flange portion, 44 lid, 55 feed pipe, 56 discharge port, 60 syringe, 62 cylinder, 63 cylinder body, 64 needle, 66 piston, 67 piston body, 68 gasket, 81 barrier layer, L liquid

1. A liquid-containing container containing a liquid, comprising:
a container body with an opening portion; and a stopper that closes the opening portion and has oxygen permeability,
wherein the stopper includes a stopper body portion and a barrier layer provided on at least part of a surface of the stopper body portion, and
the barrier layer constitutes at least a surface of a portion of the stopper to be inserted into the container body and a surface of the stopper defining a storage space for the liquid and includes at least one selected from the group consisting of a p-xylylene layer, a diamond-like carbon layer, and a fluoropolymer layer.

2. The liquid-containing container according to claim 1, wherein the stopper body portion contains silicone.

3. The liquid-containing container according to claim 1, wherein a total oxygen permeability coefficient αₐₗₗ (cm³·20 μm/(m²·day·atm)) of the stopper, a thickness w1 (μm) of the stopper body portion, a thickness w2 (μm) of the barrier layer, and an opening area A (m²) of the opening portion satisfy the following formula (1).
$$[ Math . 1 ]$$
$${α}_{all} \times 20 / ( w 1 + w 2 ) \geq 0.1 / A \qquad formula ( 1 )$$

4. The liquid-containing container according to claim 1, wherein an oxygen permeability coefficient α1 (cm³·20 μm/(m²·day·atm)) of the stopper body portion, an oxygen permeability coefficient α2 (cm³·20 μm/(m²·day·atm)) of the barrier layer, and a thickness w2 (μm) of the barrier layer satisfy the following formula (2).
$$[ Math . 2 ]$$
$$α1 / 1000 \leq α2 / w 2 \qquad formula ( 2 )$$

5. The liquid-containing container according to claim 1, wherein
the barrier layer is formed of the p-xylylene layer or the diamond-like carbon layer, and
the barrier layer has a thickness of 1000 nm or less.

6. The liquid-containing container according to claim 1, wherein an oxygen permeability coefficient α1 (cm³·20 μm/(m²·day·atm)) of the stopper body portion, an oxygen permeability coefficient α2 (cm³19 20 μm/(m²·day·atm)) of the barrier layer, a thickness w1 (μm) of the stopper body portion, a thickness w2 (μm) of the barrier layer, and an opening area A (m²) of the opening portion satisfy the following formula (6).
$$[ Math . 3 ]$$
$$20 / ( w 1 / α1 + w 2 / α2 ) \geq 0.1 / A \qquad formula ( 6 )$$

7. The liquid-containing container according to claim 1, wherein
the barrier layer is formed of the fluoropolymer layer, and
the barrier layer has a thickness of 50 μm or less.

8. (canceled)

9. The liquid-containing container according to claim 1
wherein the stopper body portion constitutes a surface of the stopper forming an outer surface of the liquid-containing container, and
the stopper body portion constitutes a surface of the stopper that comes into contact with an end portion of the opening portion of the container body.

10. (canceled)

11. The liquid-containing container according to claim 1, wherein the container body has an oxygen barrier property.

12. The liquid-containing container according to claim 1, wherein the stopper comes into contact with an end portion of the opening portion of the container body and closes the opening portion so as to seal the liquid.

13. The liquid-containing container according to claim 1, wherein the stopper body portion has a thickness of 0.5 mm or more and 3 mm or less.

14. The liquid-containing container according to claim 1, wherein the container including the container body and the stopper has a total oxygen permeation amount of 0.9 (cm³/(day·atm)) or more.

15. The liquid-containing container according to claim 1, wherein the stopper has an oxygen permeation amount of 2 (cm³/(day·atm)) or more.

16. The liquid-containing container according to claim 1, wherein the stopper has a thickness of 0.5 mm or more and 3 mm or less.

17. A liquid-containing combined container comprising:
the liquid-containing container according to claim 1; and
a barrier container that stores the liquid-containing container and has an oxygen barrier property.

18. The liquid-containing combined container according to claim 17, comprising a deoxidizer for absorbing oxygen in the barrier container.

19. (canceled)

20. A stopper that closes an opening portion of a container body of a container for containing a liquid and has oxygen permeability, comprising:
a stopper body portion containing silicone and a barrier layer provided on at least part of a surface of the stopper body portion,
wherein the barrier layer constitutes at least a surface of a portion of the stopper to be inserted into the container body and a surface of the stopper defining a storage space for the liquid and includes at least one selected from the group consisting of a p-xylylene layer, a diamond-like carbon layer, and a fluoropolymer layer.

21. A method for producing a liquid-containing container, comprising:
a step of closing a barrier container that stores a container; and
a step of adjusting an amount of oxygen in the container,
wherein the container includes a container body that contains a liquid and has an opening portion and a stopper that closes the opening portion and has oxygen permeability,
the stopper includes a stopper body portion containing silicone and a barrier layer provided on at least part of a surface of the stopper body portion,
the barrier layer constitutes at least a surface of a portion of the stopper to be inserted into the container body and a surface of the stopper defining a storage space for the liquid and includes at least one selected from the group consisting of a p-xylylene layer, a diamond-like carbon layer, and a fluoropolymer layer, and
in the step of adjusting the amount of oxygen, a concentration of oxygen in the container is reduced by permeation of oxygen contained in the container through the stopper.

22. A container for containing a liquid, comprising:
a container body with an opening portion; and the stopper according to claim 20 that closes the opening portion.
